(19) United States
(12) Patent Application Publication
(10) Pub. No.: US 2012/0290492 A1
(43) Pub. Date: Nov. 15, 2012

(54) COMPUTER-IMPLEMENTED METHODS AND SYSTEMS FOR DETERMINING ZONING CODE COMPLIANCE

(76) Inventor: Max Enrique Zabala Rodriguez, Miami, FL (US)

(21) Appl. No.: 13/467,144

(22) Filed: May 9, 2012

Related U.S. Application Data
(60) Provisional application No. 61/484,432, filed on May 10, 2011.

(51) Int. Cl. G06Q 99/00

(52) U.S. Cl. 705/317

(57) ABSTRACT

Computer-implemented methods and systems for determining zoning code compliance are disclosed. Such methods and systems seek to overcome frustrations and alleviate other impediments that affect efficient use of zoning codes, particularly form-based zoning codes. In a first aspect, a computer-implemented system for determining zoning code compliance includes at least one input interface for receiving property information; a computer program for calculating zoning code criteria and assessing zoning code compliance, using the property information; and at least one output interface for displaying assessment of zoning code compliance.

### RELATED APPLICATIONS

This application claims priority to U.S. Provisional Patent Application Ser. No. 61/484,432, filed on Mar. 31, 2010. The disclosure of the aforementioned priority document is incorporated herein by reference in its entirety.

### BACKGROUND

1. Field of the Invention

The field of the present invention relates to computer-implemented methods and systems for determining zoning code compliance.

2. Background

Most developed municipalities in the world use zoning to regulate land use. To implement zoning, municipalities enact regulations called zoning codes. Various types of zoning codes are used by municipalities to facilitate urban design and planning.

In one type of code, called a form-based code, each property is allocated within a specified density zone. Density zones are included on a zoning map, which has colorized representations of each specified density zone. Density zones may be affected by surroundings in municipalities, including, but not limited to, public transit systems, historic preservation sites, and various types of civic uses.

Model form-based codes, such as the SmartCode developed by Duany Plater Zyberk & Company, are frequently adopted by municipalities to create neighborhoods that incorporate character and reflect community vision. In using these types of codes, once the allocation of property is complete, the code is often manually referenced by developers to assess density capacity. If necessary, a developer will increase density capacity after consideration of several factors, which are codified in the zoning code.

Developers may then determine building criteria in accordance with the municipality's zoning code. For example, a developer may choose to consider various building types, heights, uses, and parking options. After the criteria are determined, the developer will typically submit a permit application to the municipality, requesting approval. The municipality then engages in a similar process to assess whether the developer is in compliance with the zoning code.

While this process is suitable for some, many developers find manual reference to zoning codes time-consuming and frustrating, particularly developers seeking to assess alternative criteria. Instead of seeking one set of criteria for development, developers may want to try alternative uses, densities, building types, etc. In addition, municipalities may also find manual reference to form-based zoning codes particularly frustrating, upon reviewing multiple criteria submitted by developers. As such, there is a clear need for methods and systems which seek to relieve the frequent frustrations and impediments encountered by municipalities and developers in determining zoning code compliance.

### SUMMARY

The present invention is directed toward computer-implemented methods and systems for determining zoning code compliance and seeks to overcome frustrations and alleviate other impediments that affect efficient use of zoning codes, particularly form-based zoning codes.

In a first aspect, a computer-implemented system for determining zoning code compliance includes at least one input interface for receiving property information; at least one computer program for calculating zoning code criteria and assessing zoning code compliance, using the property information; and at least one output interface for displaying assessment of zoning code compliance.

In a second aspect, a computer program for determining zoning code compliance includes a computer-usable storage medium having computer-readable program code executed on a computer for (A) entering, by way of human intervention, lot information for a property; (B) calculating parameters specified by the zoning code based upon the entered lot information; (C) determining whether the calculated parameters are in compliance with zoning code parameters; and (D) outputting whether the calculated parameters are in compliance with zoning code parameters.

And, in a third aspect, a computer-implemented method of determining zoning code compliance includes inputting property information into a computer-implemented interface; calculating parameters specified in a zoning code; assessing zoning code compliance; and then outputting results of zoning code compliance in a computer-implemented interface.

### BRIEF DESCRIPTION OF THE DRAWINGS

The drawings described herein are for illustrative purposes only and are not intended to limit the scope of the present disclosure.

In the drawings:

FIG. 1 is a schematic view of a computer-implemented system for determining zoning code compliance;

FIGS. 2-3 show interface examples that could be used by a municipality;

FIGS. 4-9 show interface examples that could be used by a property developer;

FIG. 10 shows an interface example that could be used by a community developer;

FIGS. 11-14 show calibration tables, which could be customized based upon municipality specific information and zoning codes;

FIG. 15 shows interface examples for Lot Density/Type Compliance in a web-based application;

FIG. 16 shows interface examples for Lot Use/Configuration Compliance in a web-based application; and

FIGS. 17-21 show interfaces of customized and calibrated version of the system for an implemented Zoning Compliance System for a municipality.

### DETAILED DESCRIPTION

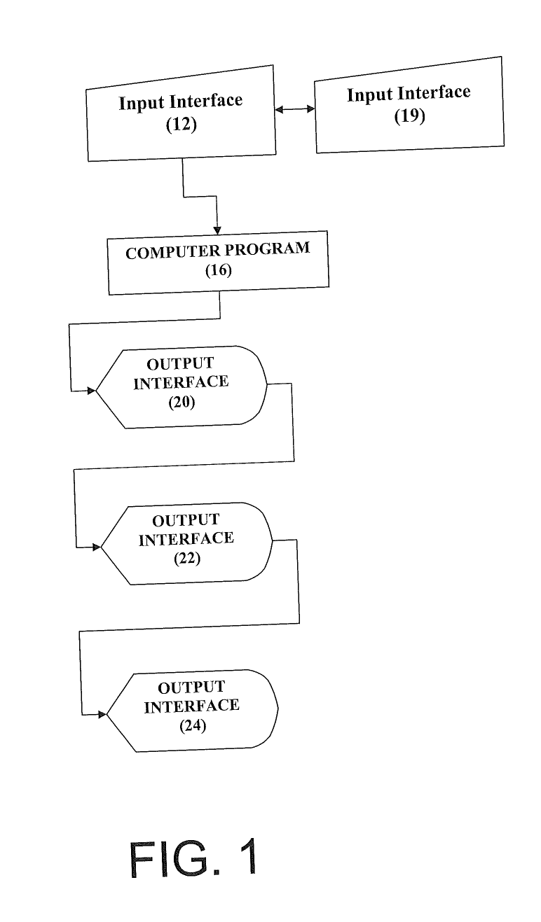

Turning in detail to the drawings, FIG. 1 illustrates schematically a computer implemented system 10 for determining zoning code compliance. The system 10 can have different interfaces and complexity, depending on the target audience. Where the target audience is a developer who is not familiar with a particular zoning code, the system 10 can use simplified interfaces. The system 10 includes an input interface 12 for receiving property information 14; a computer program 16 for calculating zoning code criteria 18 and assessing zoning code compliance, using the property information 14; and output interfaces 20, 22, 24 for displaying assessments 26 of zoning code compliance.

A user, such as a developer or a municipal employee, will initially input property information 14 into an input interface 12. The input interface 12 is any interface configured for manual or automatic input by an individual or a computer. Types of input interfaces can include: a tactile or virtual keyboard, a mouse, a smart keyboard, a phone keypad, a voice recognition interface or any other interface that allows a user to input property information. Other contemplated input interfaces include GOOGLE® Earth and/or geographic information systems (“GIS”). Preferably, the system 10 is configured to extract basic lot information from geographically based systems 11 (not shown). Users can navigate to a property, using these geographically based systems 11 and link with the system 10 such that all necessary property information is extracted.

The property information 14, includes, but is not limited to, a T-Zone or Density Zone specifier, lot width, lot depth, primary right-of-ways (ROW), community type, and property surroundings. The community type may be regional corridor development, traditional neighborhood development, cluster development, or any other community types outlined by the zoning code.

After initial input, the system 10 further includes one or more computer programs 16 or computer executed codes that calculate zoning code parameters based upon the inputted property information. The computer program 16 may be uploaded or downloaded onto any computer, using web-based interfaces, computer discs, etc. The program 16 may be pre-loaded with zoning code parameters 17 (not shown) for a designated municipality. Preferred zoning code parameters include form-based codes, such as those based upon SmartCode version 9.2 or higher, which is incorporated by reference herein in its entirety.

The computer programs 16 can calculate, for example, T-Zone graphical parameters, lot area, lot allowed density, lot developable units, building disposition, and permitted areas for frontage. In addition, the program 16 can have a separate input interface 19 that is linked to update zoning codes after codification. This allows the program 16 to calculate code parameters in real-time.

Based upon the calculated parameters, the system 10 further includes output interfaces 20, 22 for displaying the assessment 26 (not shown) of zoning code compliance. Output interfaces include computer monitors and screens coupled to cell phones, tablet devices, etc. A first output interface 20 will display, for example, whether the proposed property information 14 complies with lot density ranges and community types, which are codified with the specified zoning code. For example, if the inputted property information has a width larger than that required by the zoning code, the program will display if the property may be subdivided.

In the second output interface 22, a table or other suitable graphical representation 23 may be displayed. Preferably, the graphical representation has an appearance, which is similar to a generic page within the written zoning code. The interface 22 may, however, be customized by a developer or a municipality for demonstration and marketing purposes, among other things. Preferably, the second output interface 22 does not include densities, mix of uses, lot coverages, building setbacks, etc. However, the second output interface 22 does include additional information related to the property site and density zone, such as maximum building height and lot coverage. This second interface 22 further refines the initial information displayed in the first output interface 20. Moreover, in this interface 22, a user may test several mixes of uses such as commercial, lodging, retail, and residential. And, in this interface, a user may optionally “test” additional options such as the addition of a parking structure or nearby area for parking.

Optionally, for larger property sites, the system 10 may include a third output interface 24 that utilizes additional computer software or computer executed code 28 (not shown). The software or computer-executed code 28 is configured to determine proposals for re-zoning a property, using different mixtures of zoning densities, open spaces, and infrastructure areas. Each density zone will display, for example, an estimated number of dwelling units based on the allowed density within each zone.

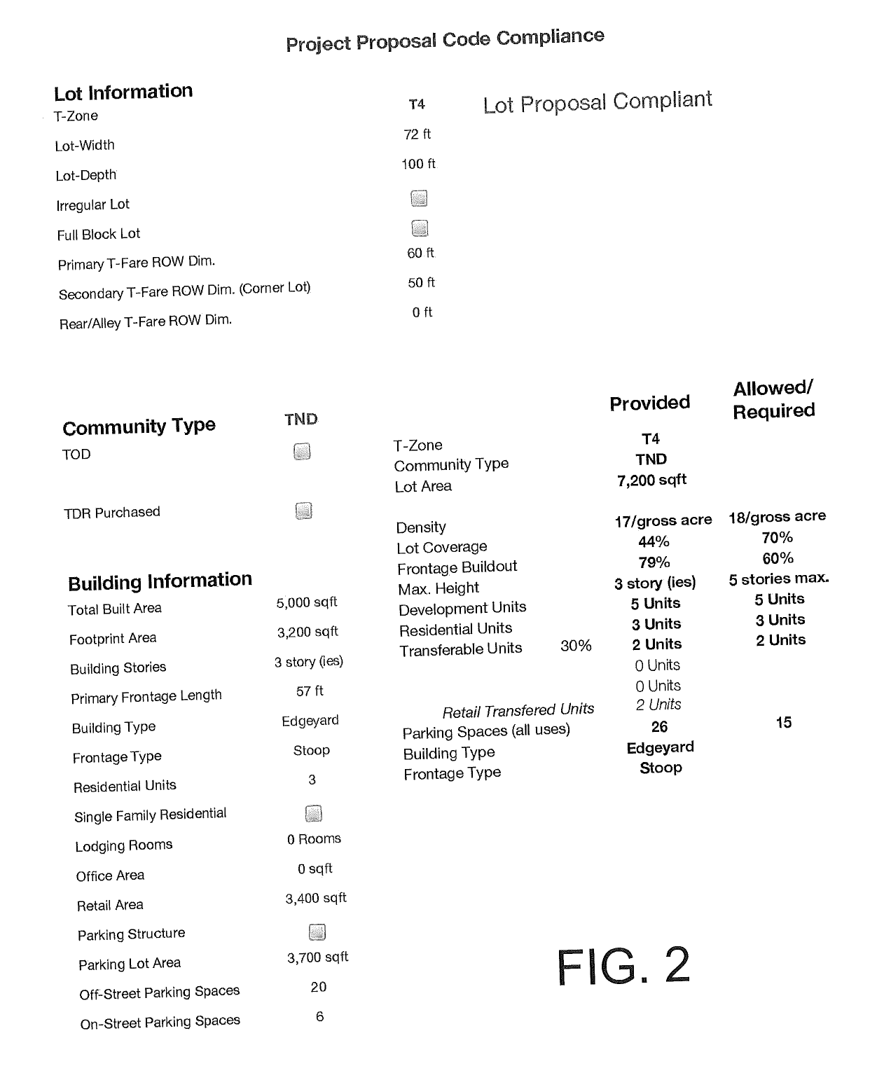

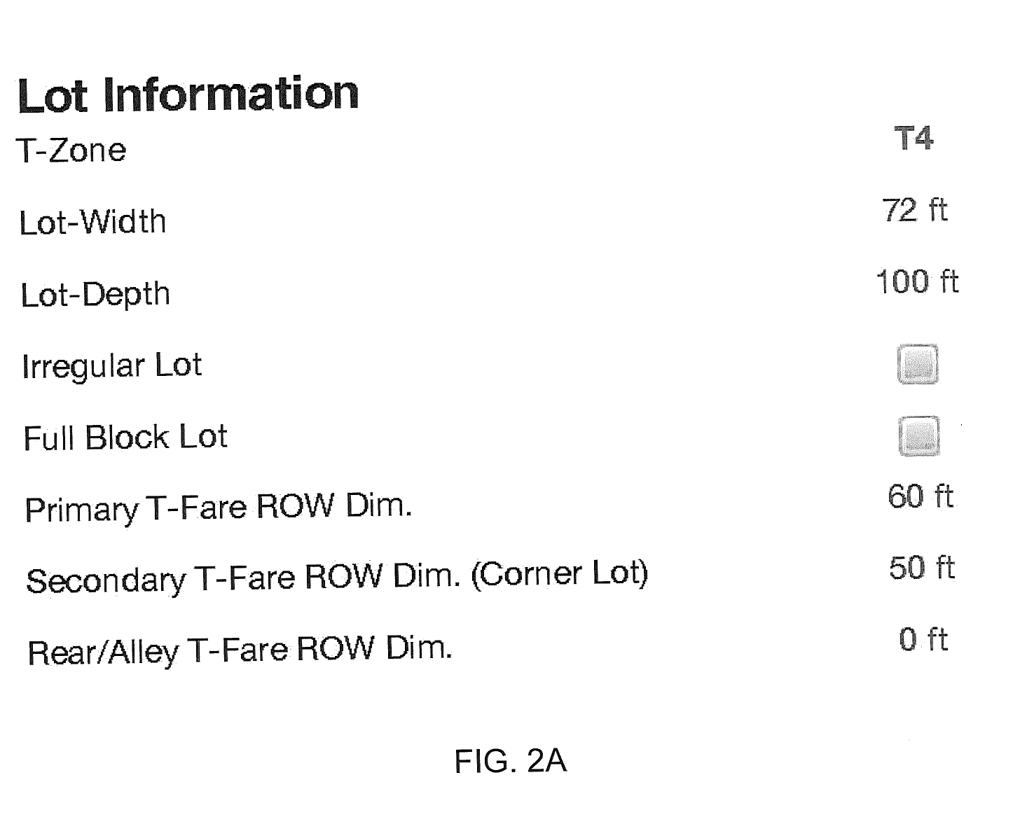

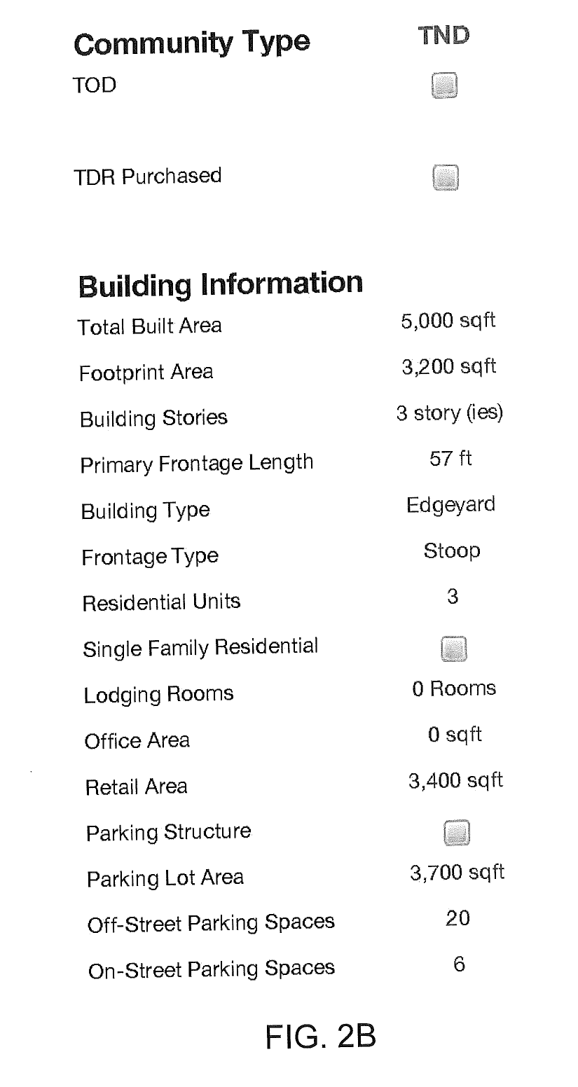

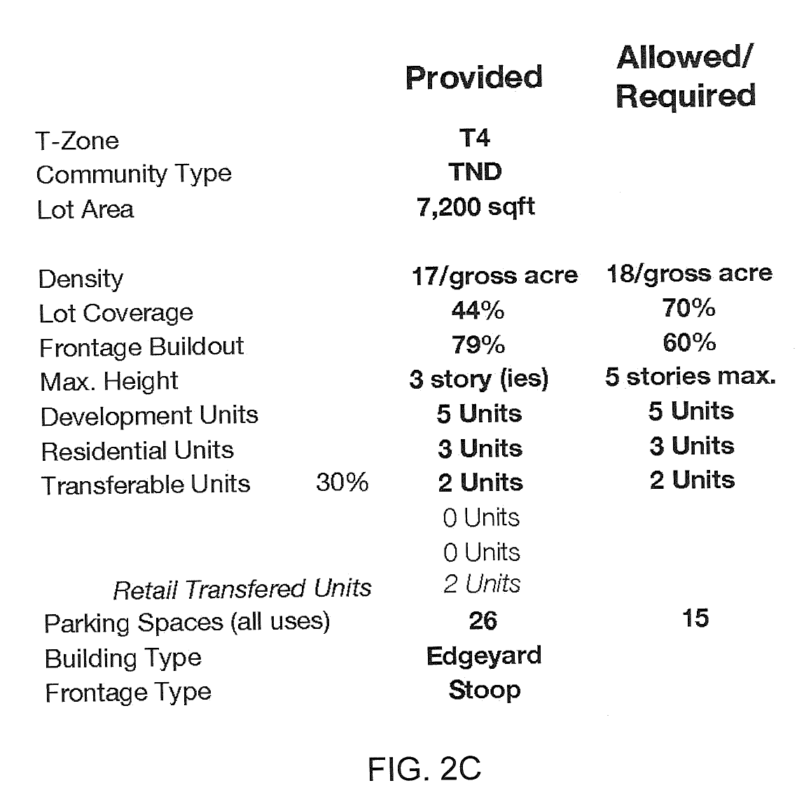

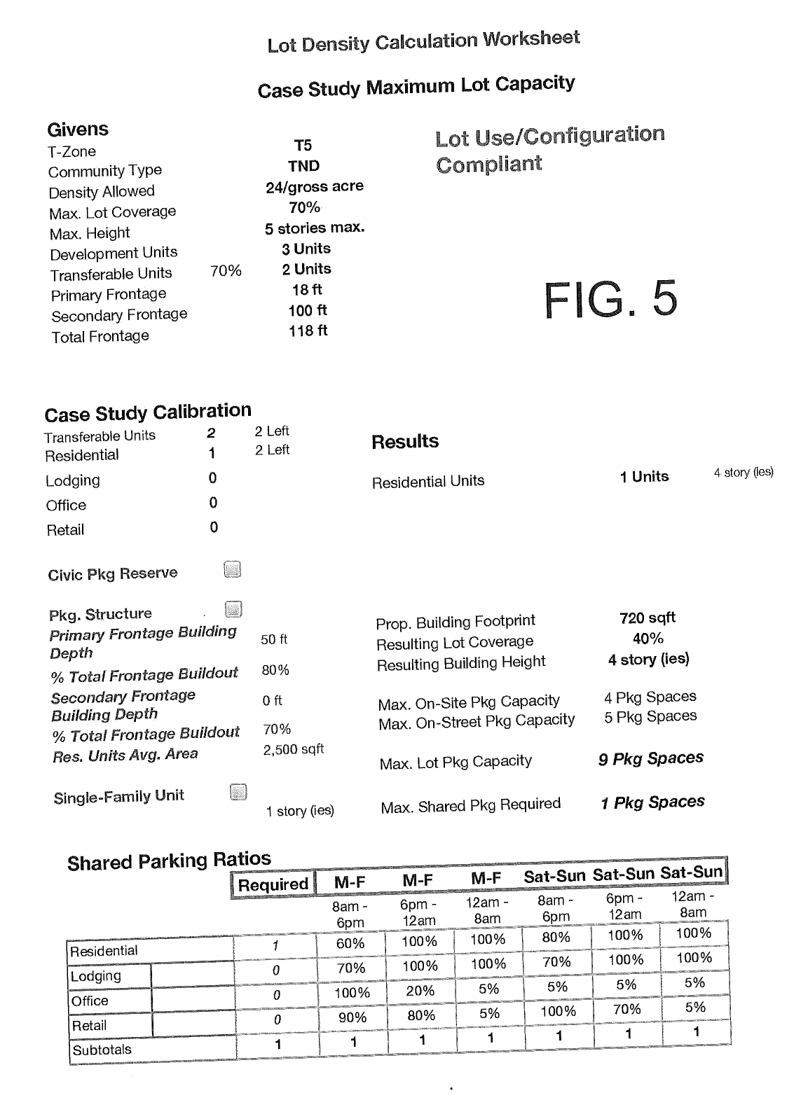

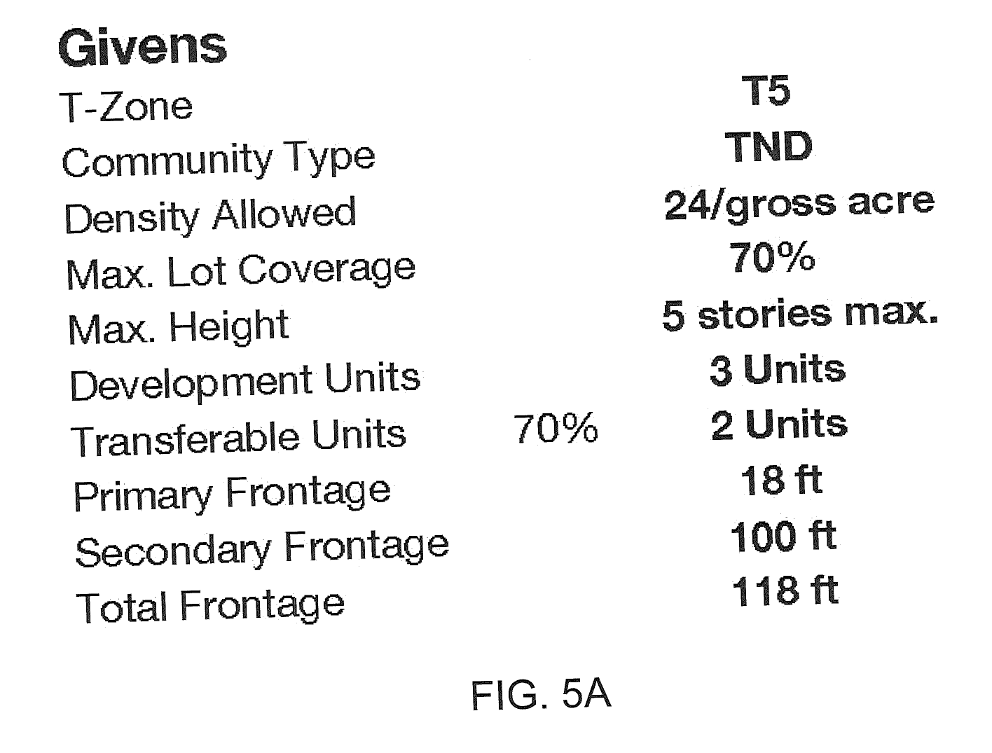

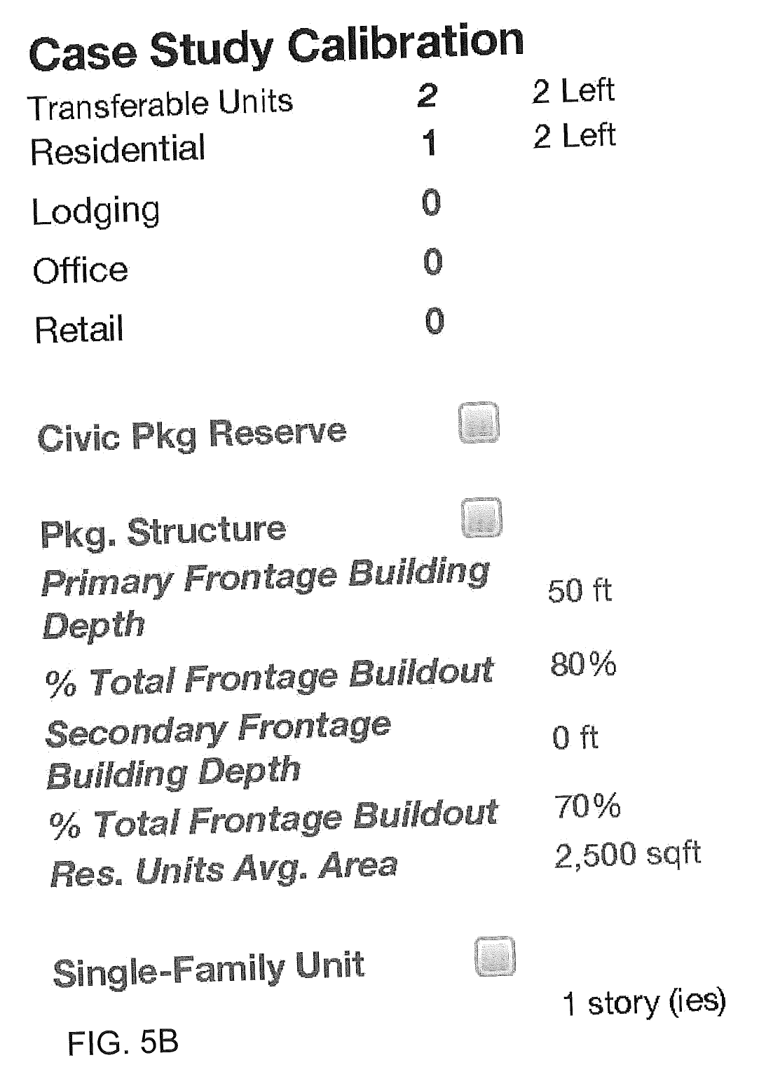

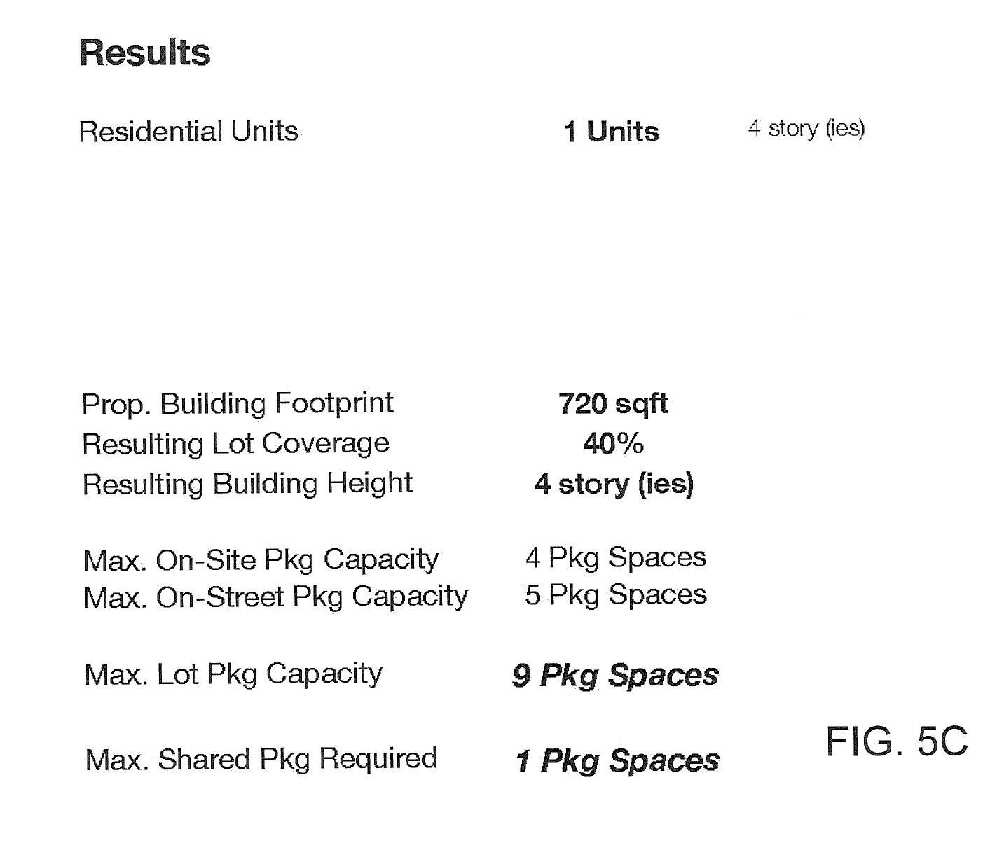

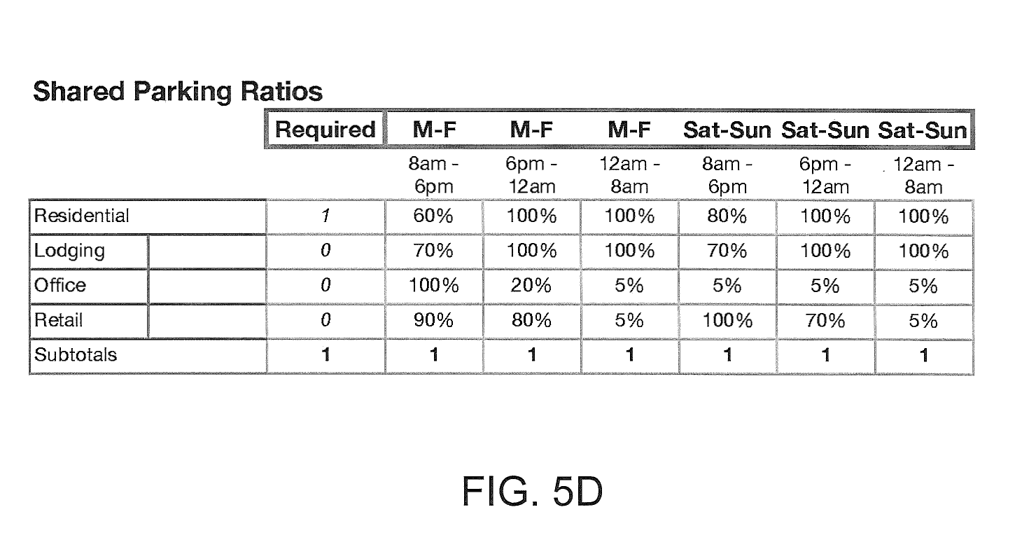

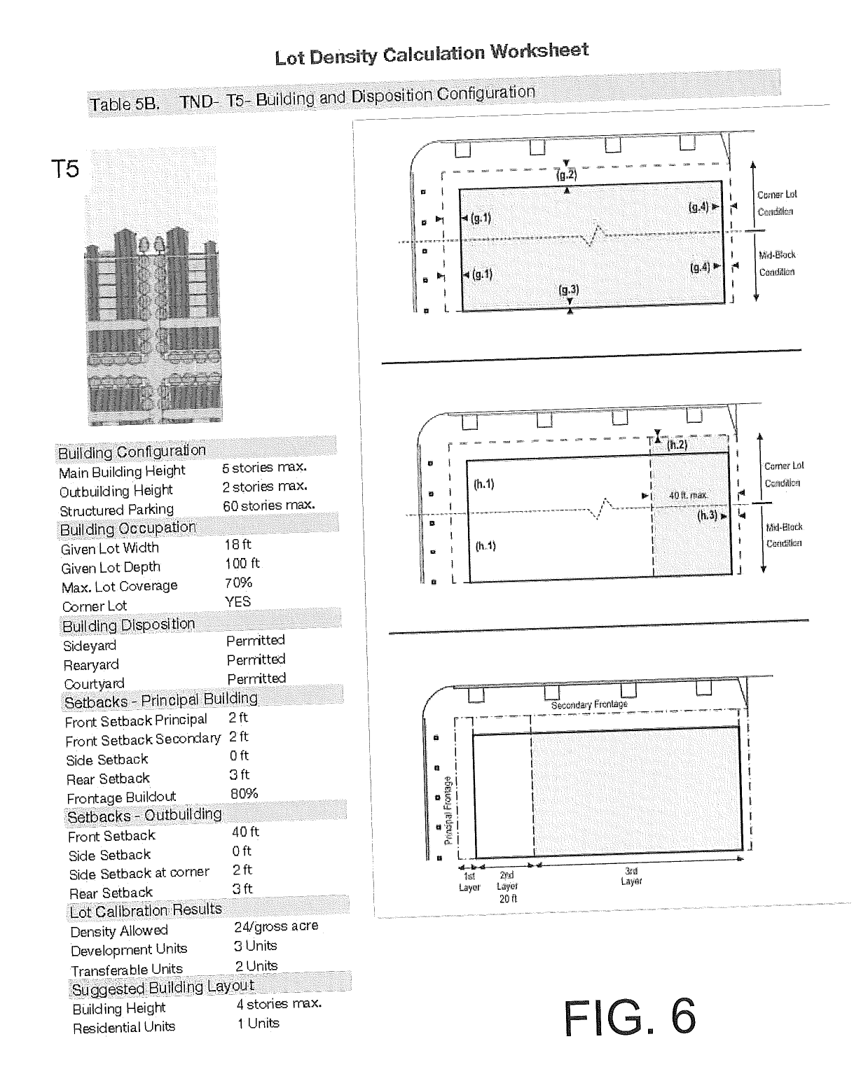

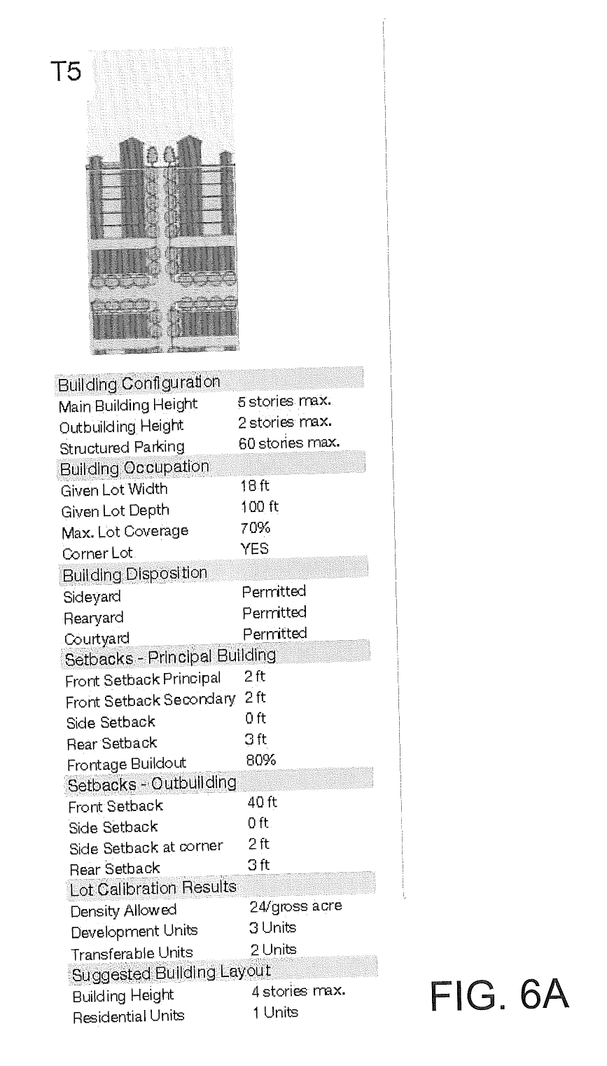

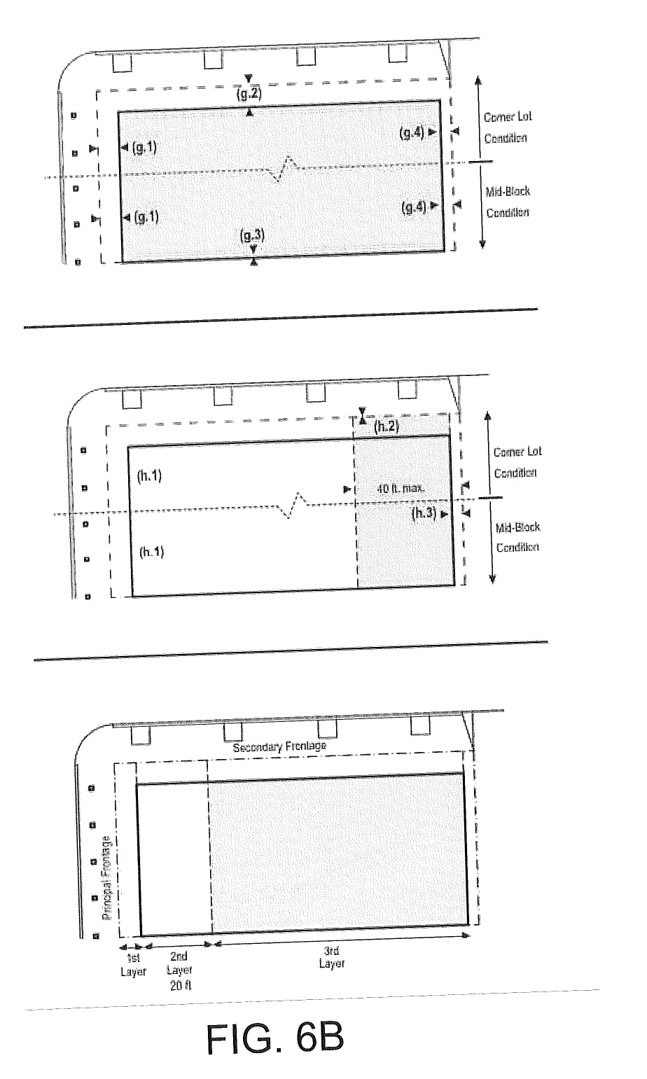

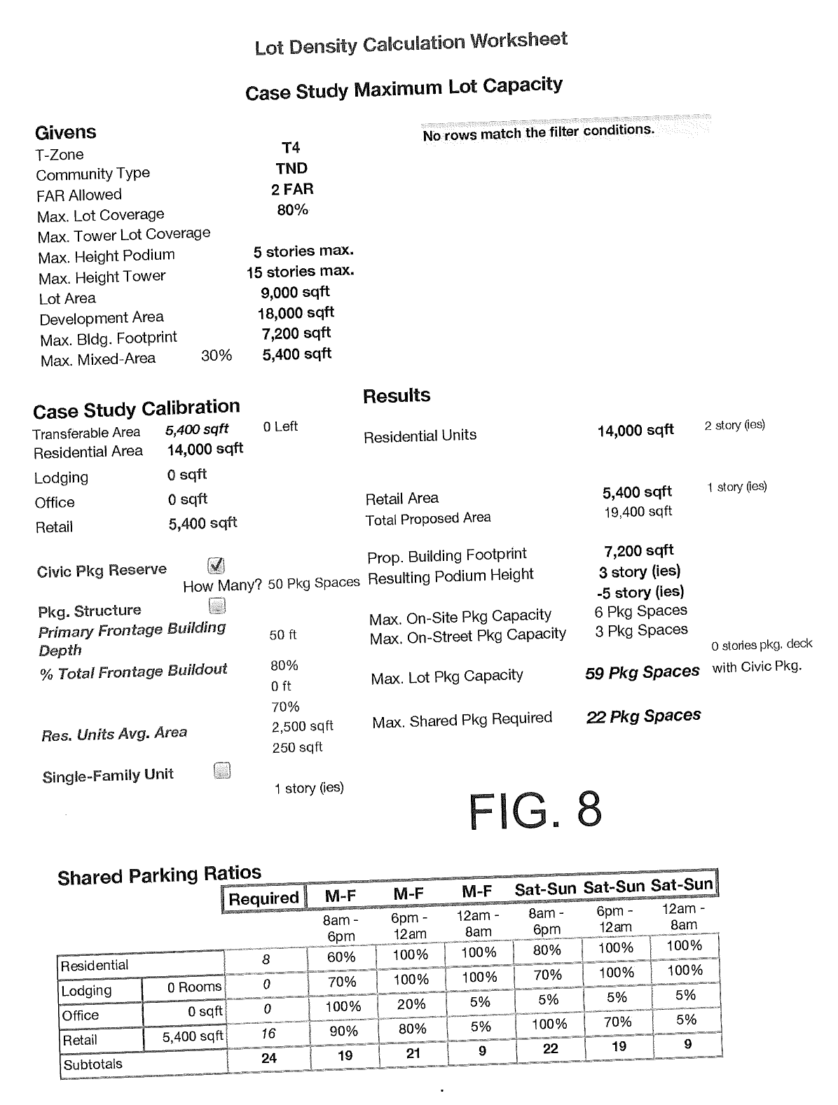

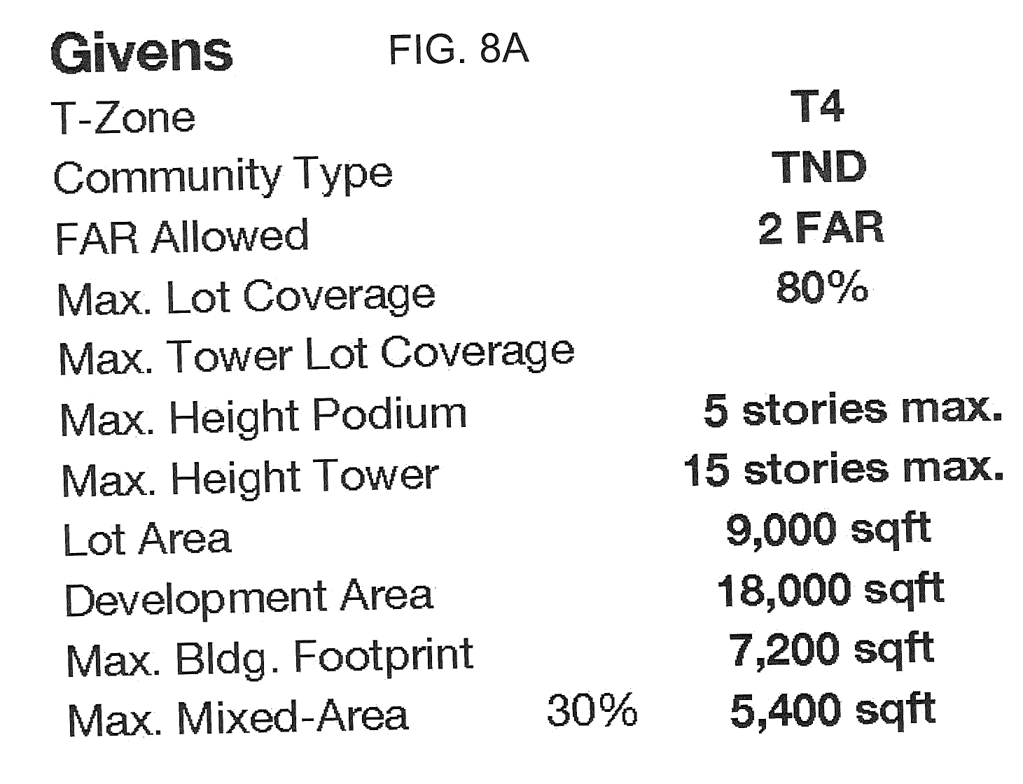

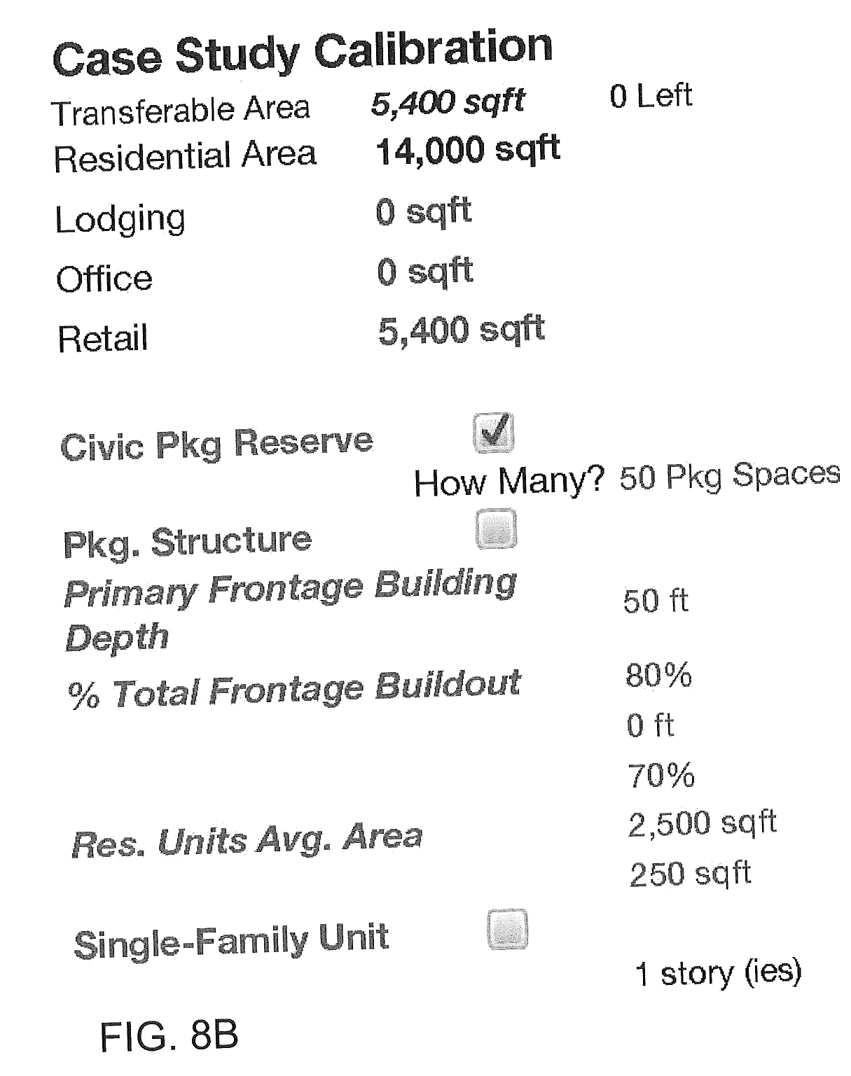

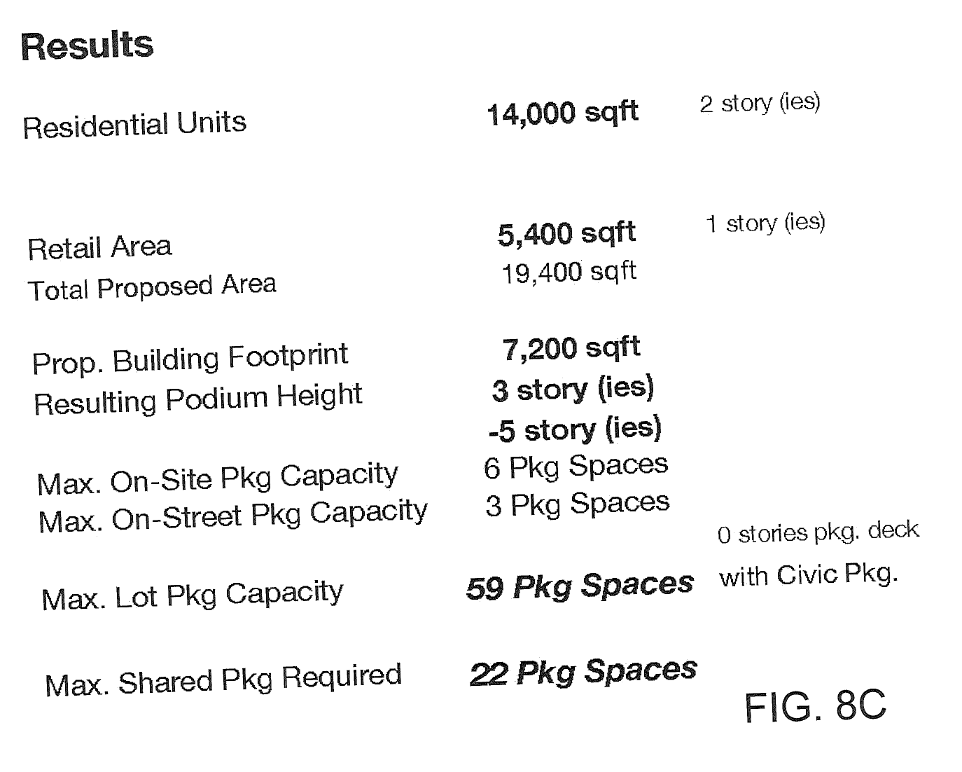

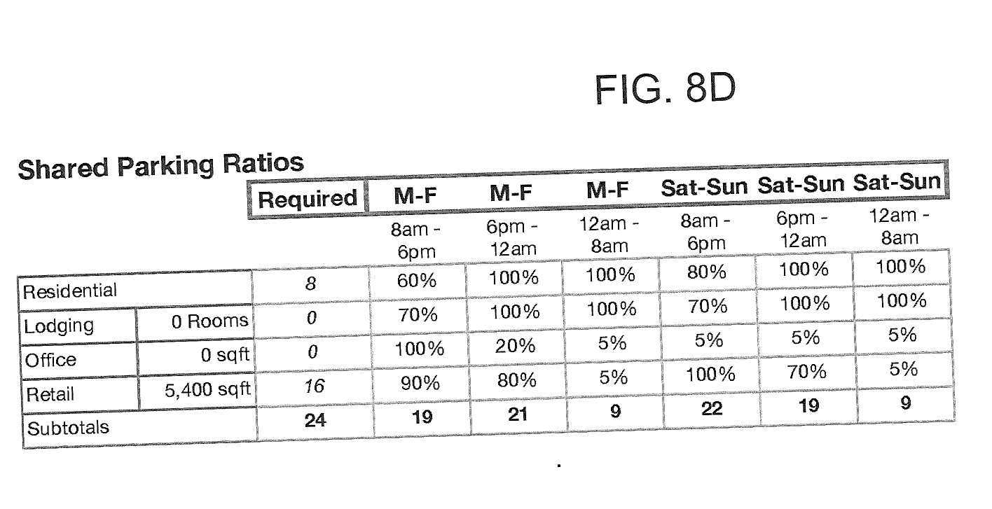

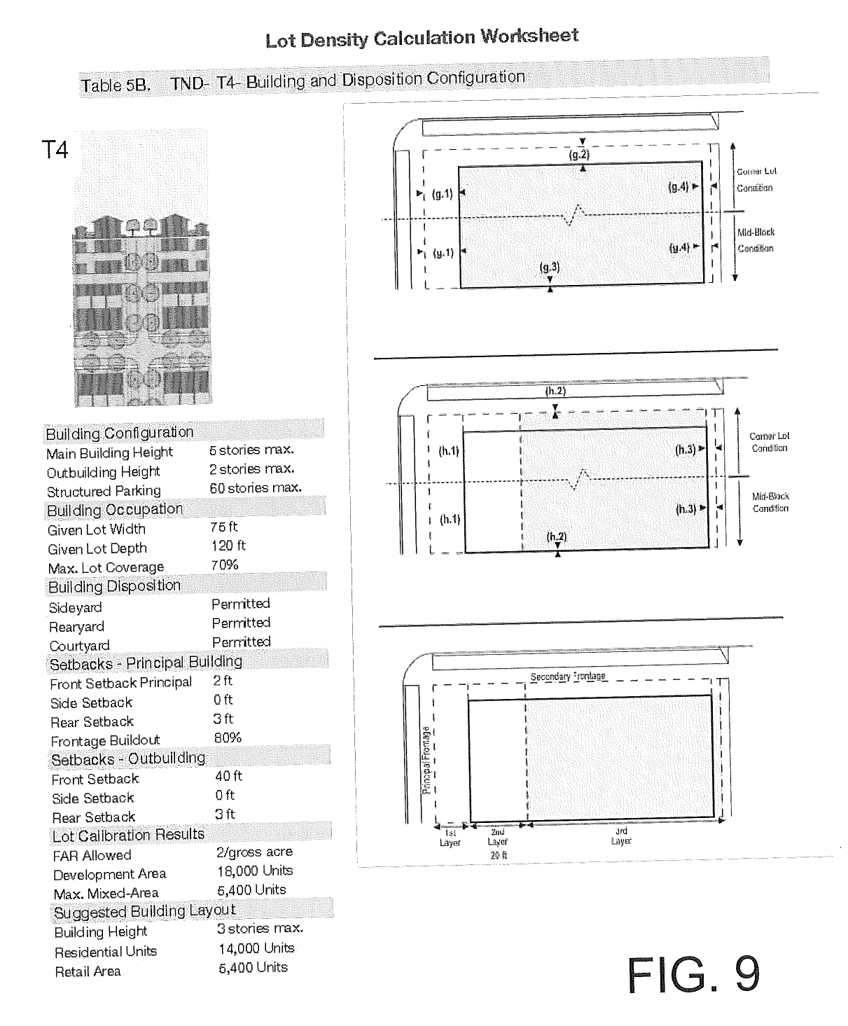

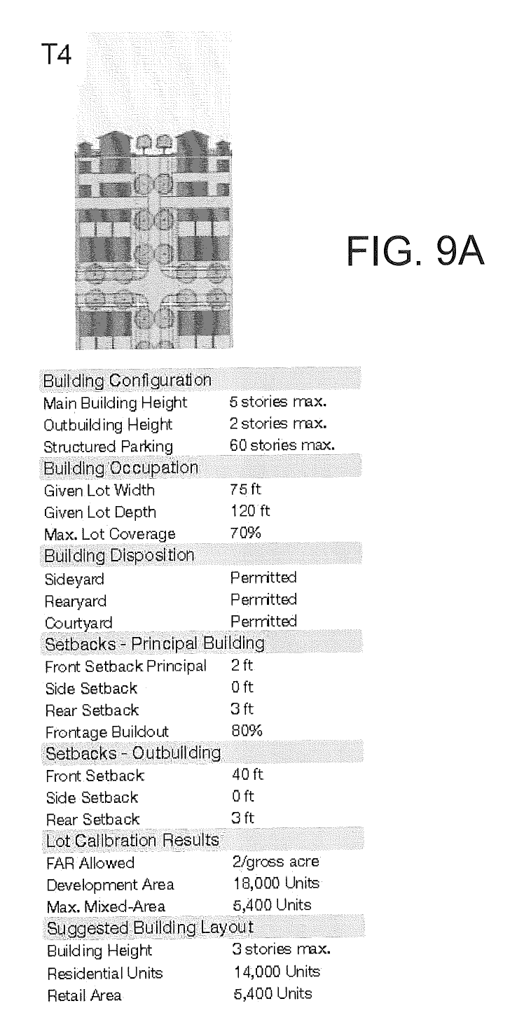

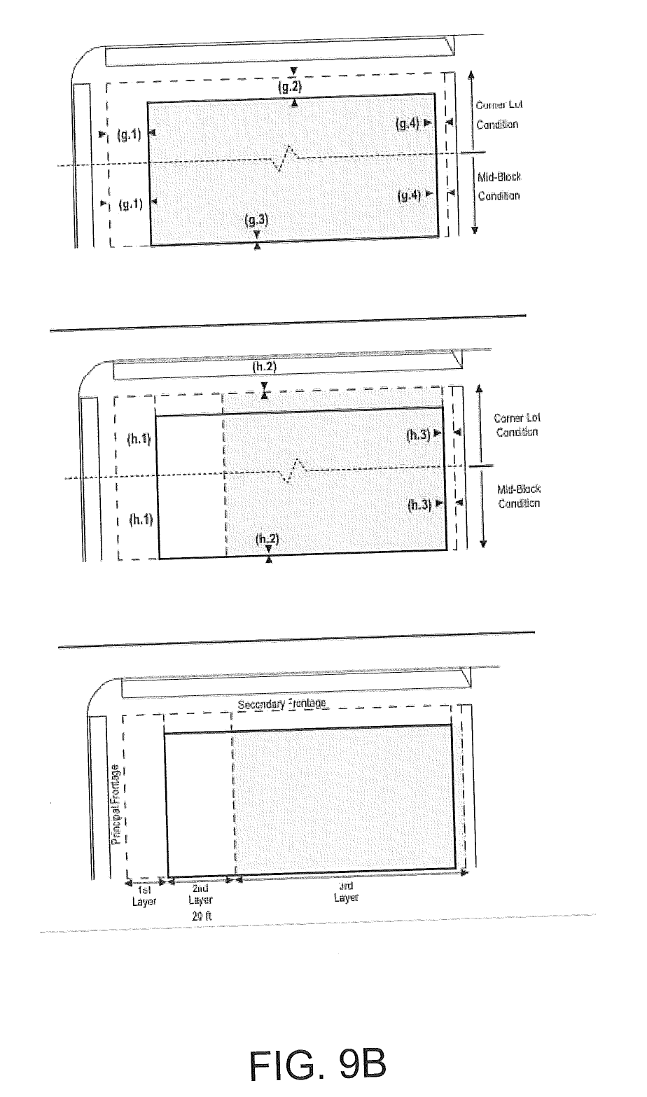

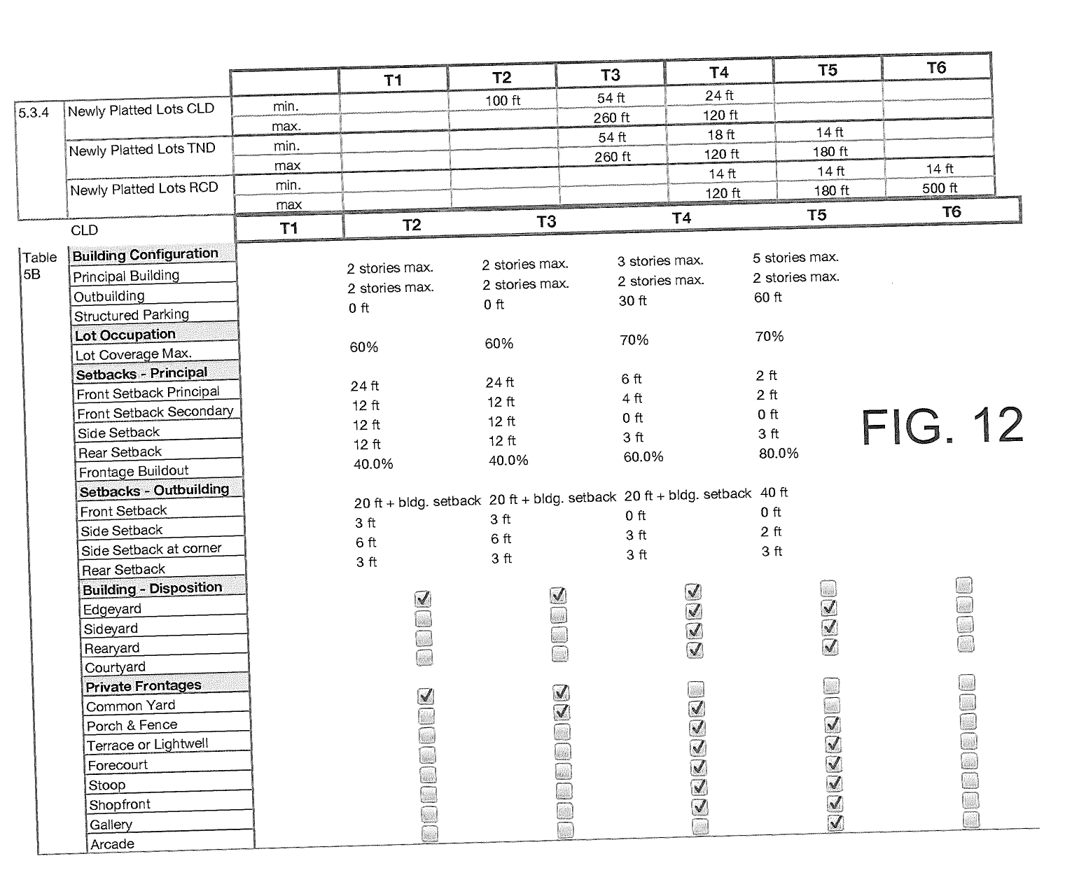

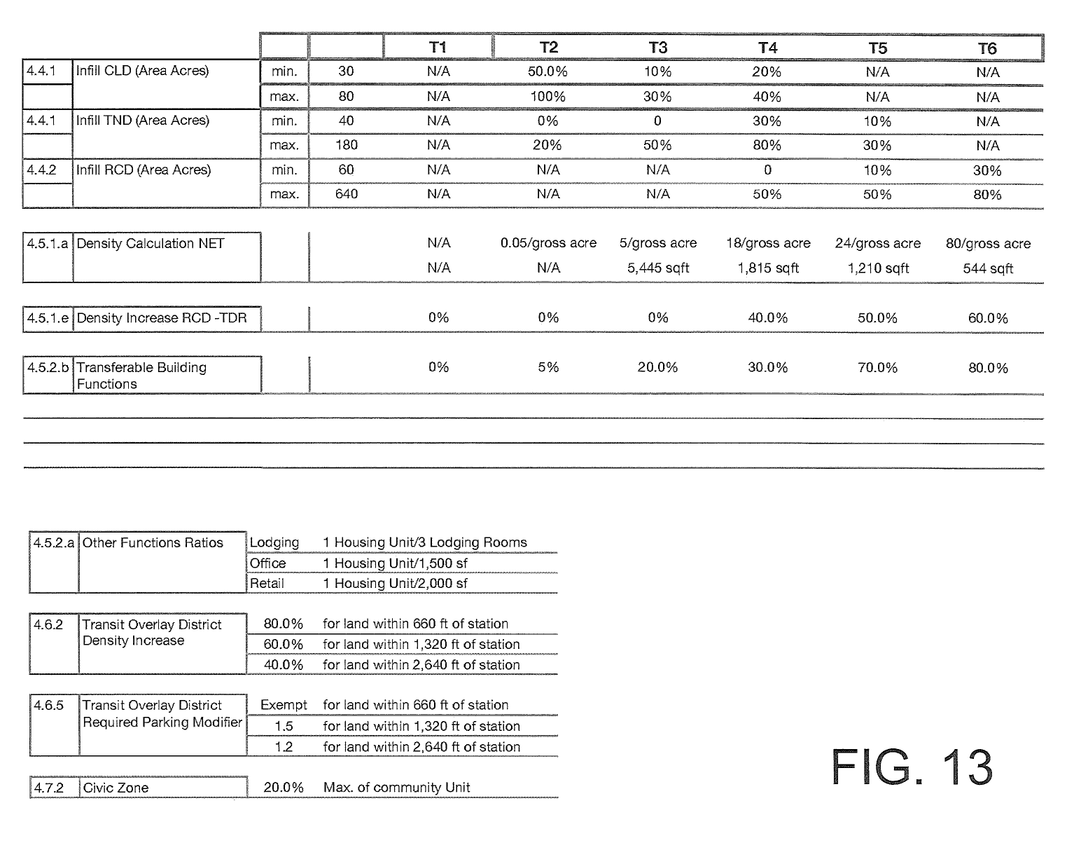

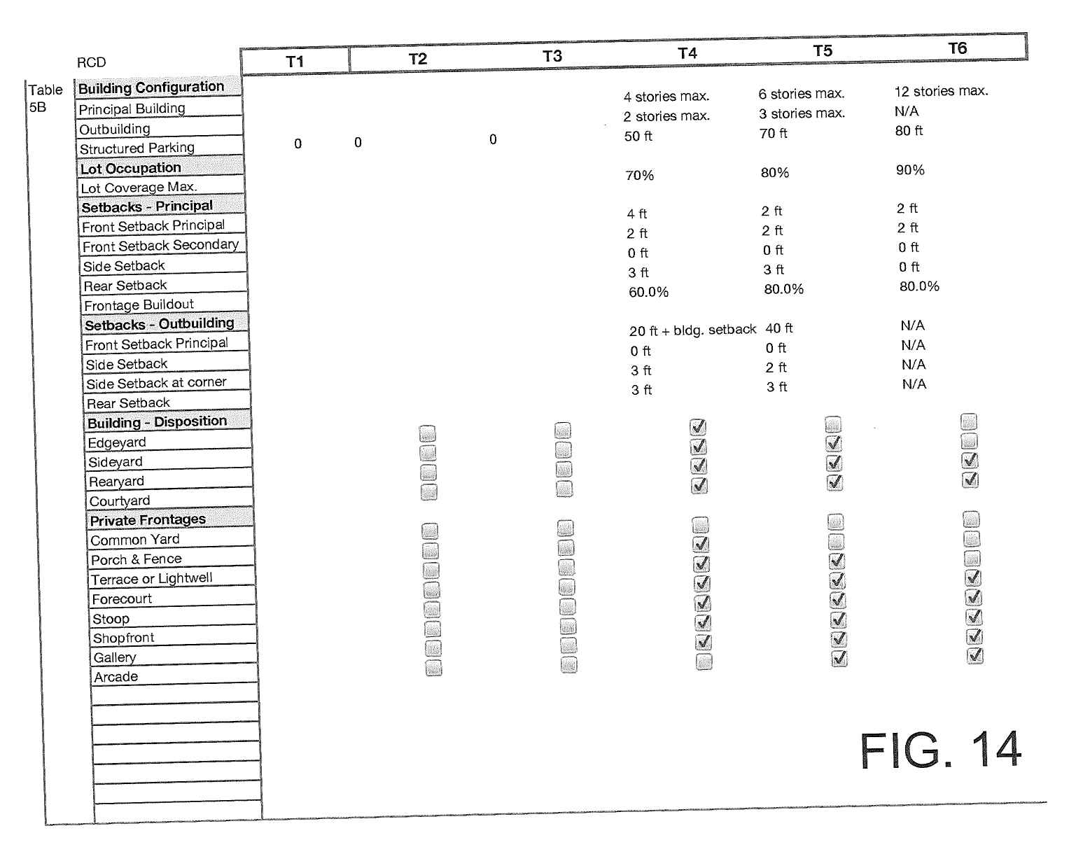

FIGS. 2-14 show various images of an embodiment of the system using a spread sheet application. Types of suitable spreadsheet applications include Microsoft® Excel, iWork® Numbers, and Quattro Pro, among others. The system may, however, be implemented using any type of computer-based application.

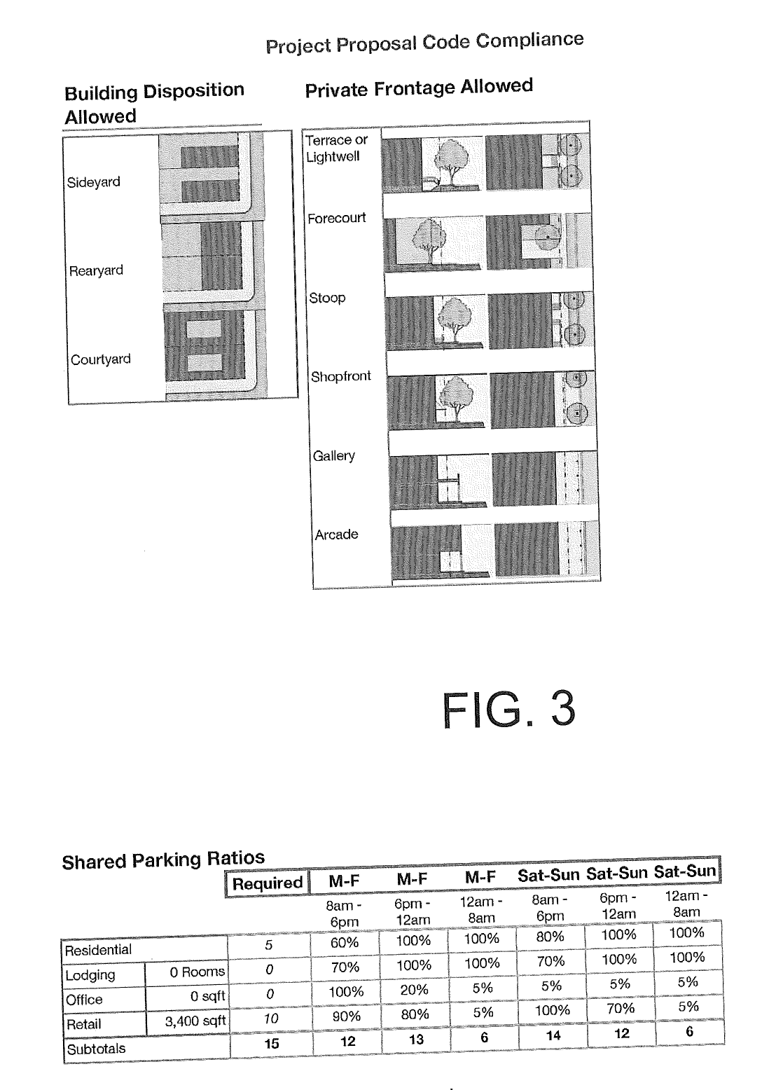

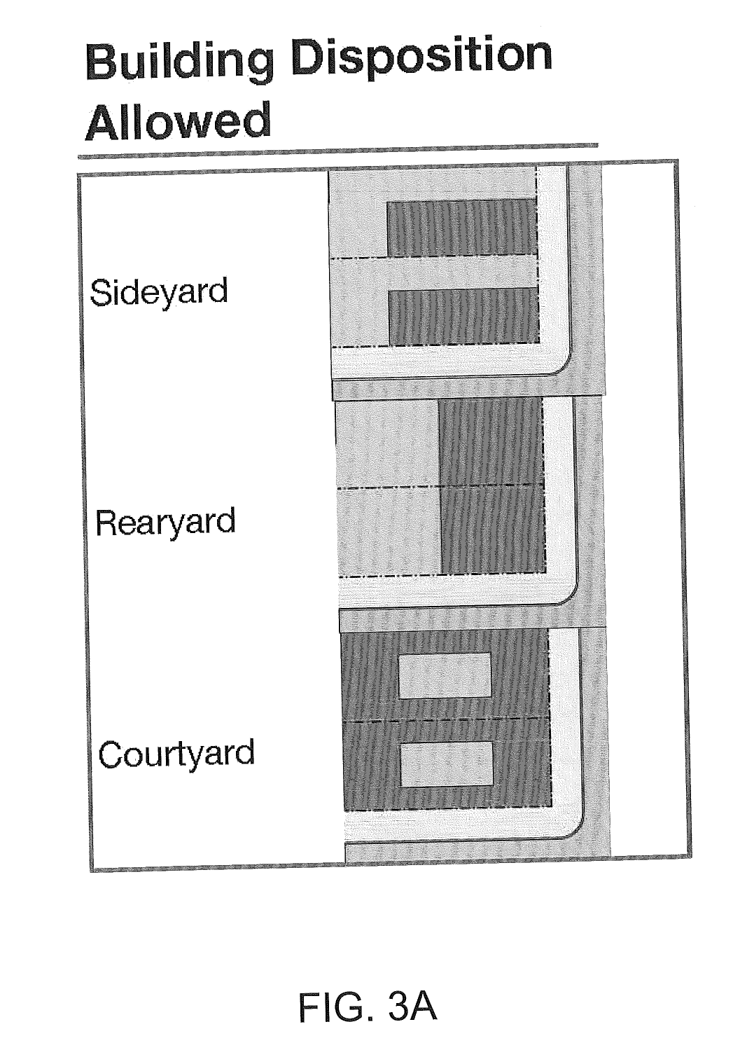

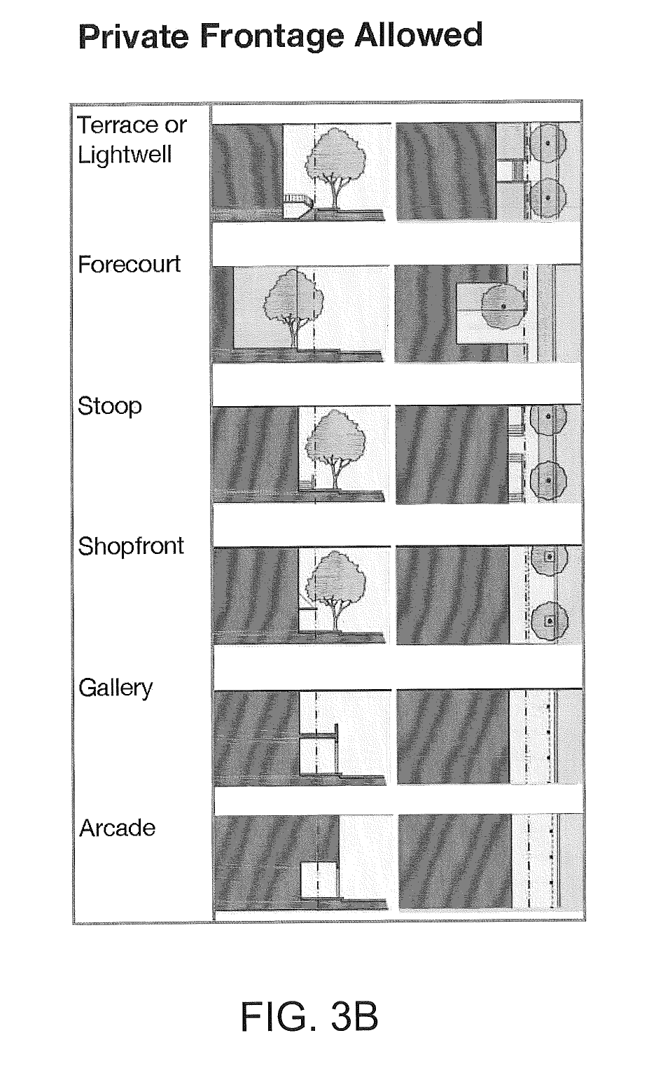

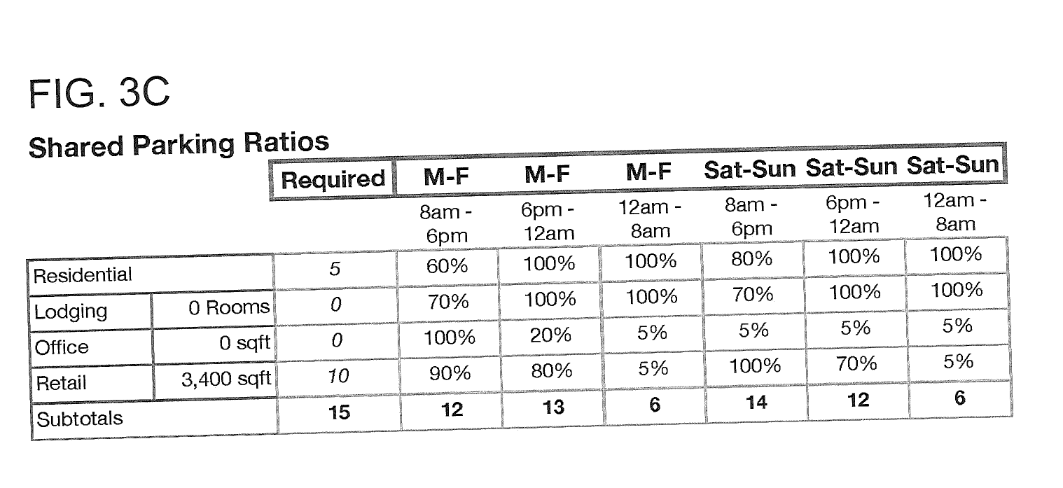

FIGS. 2-3 show input interfaces that would be seen by a user, such as a city employee. In this example, the employee would enter all of the specific parameters required for a permit application. After input, the system would indicate in real-time whether or not the parameters are in compliance with the codified zoning code. If the parameters are non-compliant, then the system will be configured to display the reason(s) for non-compliance and whether the parameters could be modified upon application of a variance.

FIG. 2 shows interfaces examples that could be used by a municipality. The left side of FIG. 2 provides input interfaces for property information 14 such as lot information, community type, and building information. In this example, the Lot Information Section has areas for T-zone, lot-width, lot-depth, dimensions for primary T-far right-of-ways, and rear or alley T-Fare right-of-ways. This section also includes selection boxes, which allow a user to indicate whether the lot is a full block lot and/or an irregular lot. The Community Type Section includes selection boxes, which allow a user to indicate whether the community type is a Transit-Oriented Development (“TOD”) or Transfer of Development Rights (“TDR”) Purchased type. The Building Information Section provides an input interface for Total Built Area, Footprint Area, Building Stories, Primary Frontage Length, Building Type, Frontage Type, Residential Units, Lodging Room, Office Area, Retail Area, Parking Lot Area, and the number o Off-Street and On-Street Parking Spaces. This Section also includes selection boxes where a user may input whether the building is Single Family Residential or whether the building includes a Parking Structure.

The right side of FIG. 2 provides examples of output interfaces, showing various calculated, pre-determined, or determined parameters. In this example, a comparison of information provided and information allowed is shown. Such values, in this example include: T-Zone, Community Types, Lot Area, Density, Lot Coverage, Frontage Buildout, Maximum Height, number of developmental, residential, and transferable unity, Parking Spaces (according to all uses), Building Types, and Frontage Type. The top right corner shows an identifier, indicating whether the Lot Proposal, based on inputted values, is compliant.

FIG. 3, for example, schematically shows types of allowed building dispositions and private frontages. The upper left side of FIG. 3 shows three types of building dispositions: a sideyard, a rearyard, and a courtyard. The upper right side of FIG. 3 shows four types of allowed private frontages: a terrace or lightwell, a forecourt, a stoop, a shopfront, a gallery, and an arcade. The bottom portion of FIG. 3 shows an example of an output interface, showing Shared Parking Ratios over specified periods. Here, times and days of the week are shown based on the type of residential space: lodging, office, and retail.

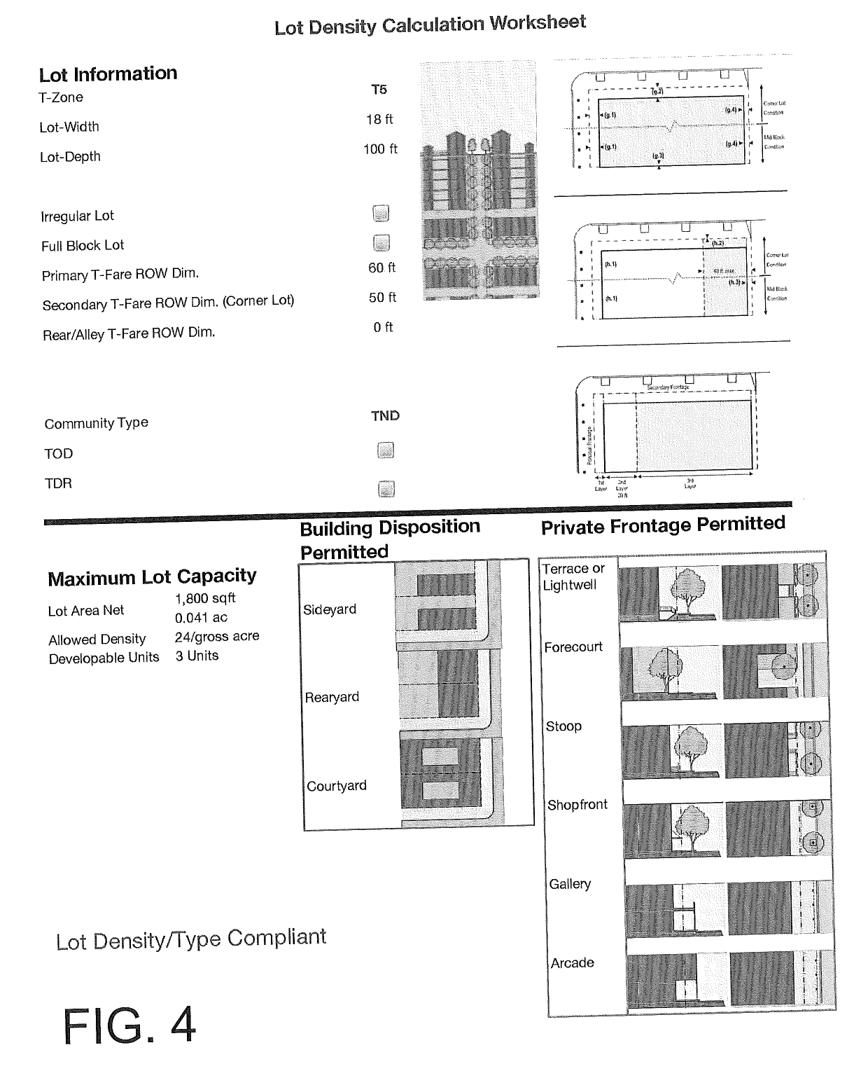

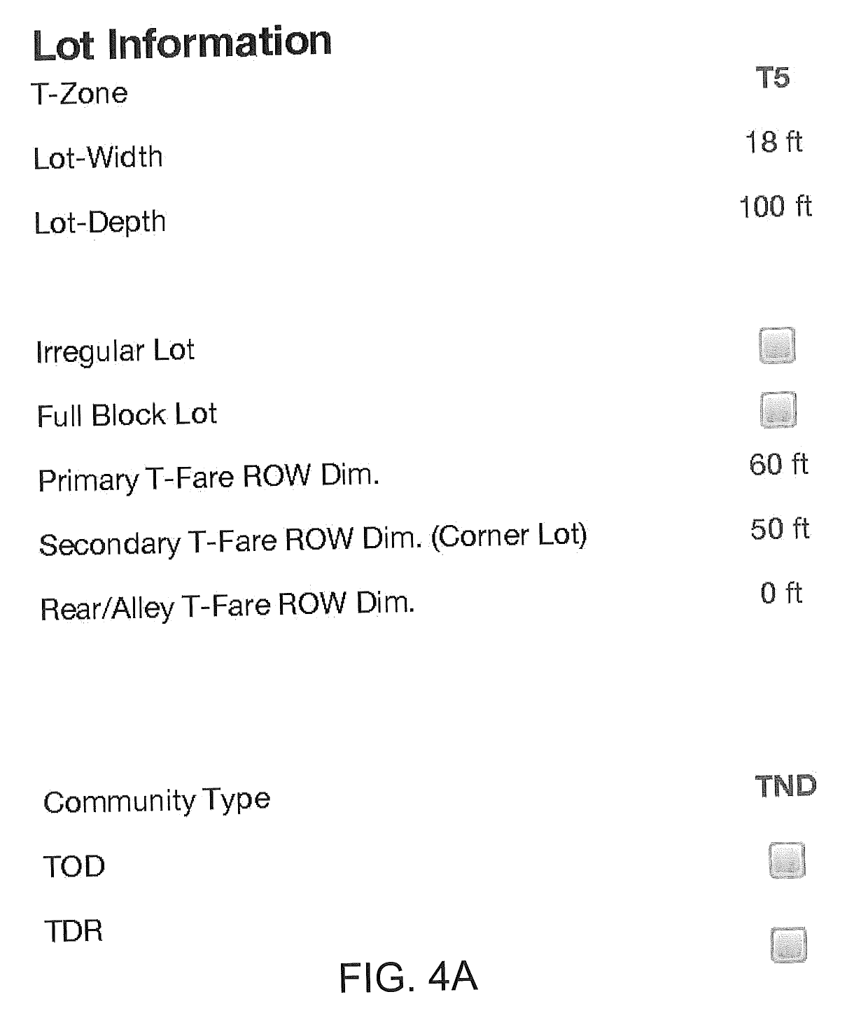

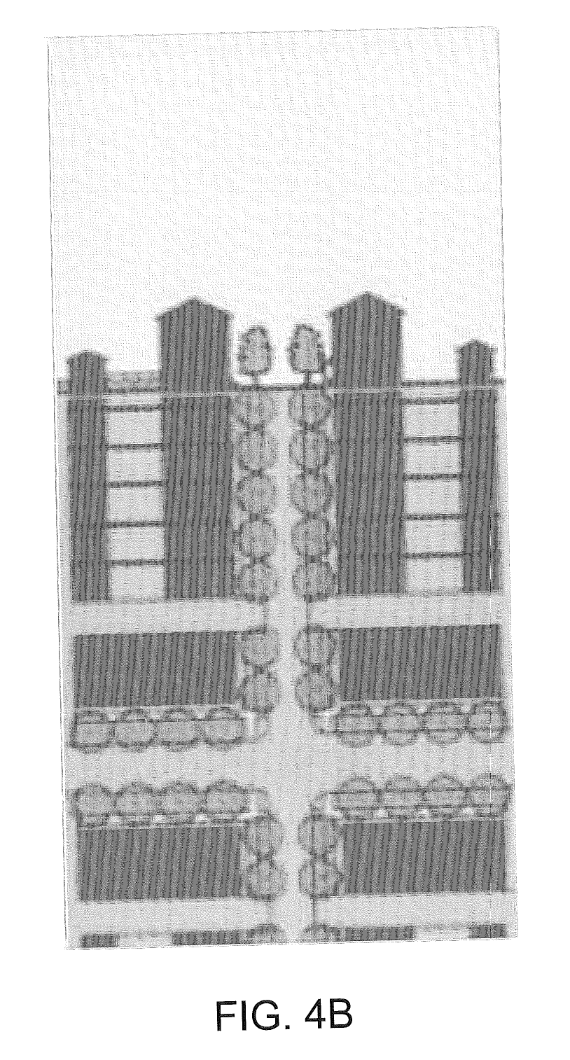

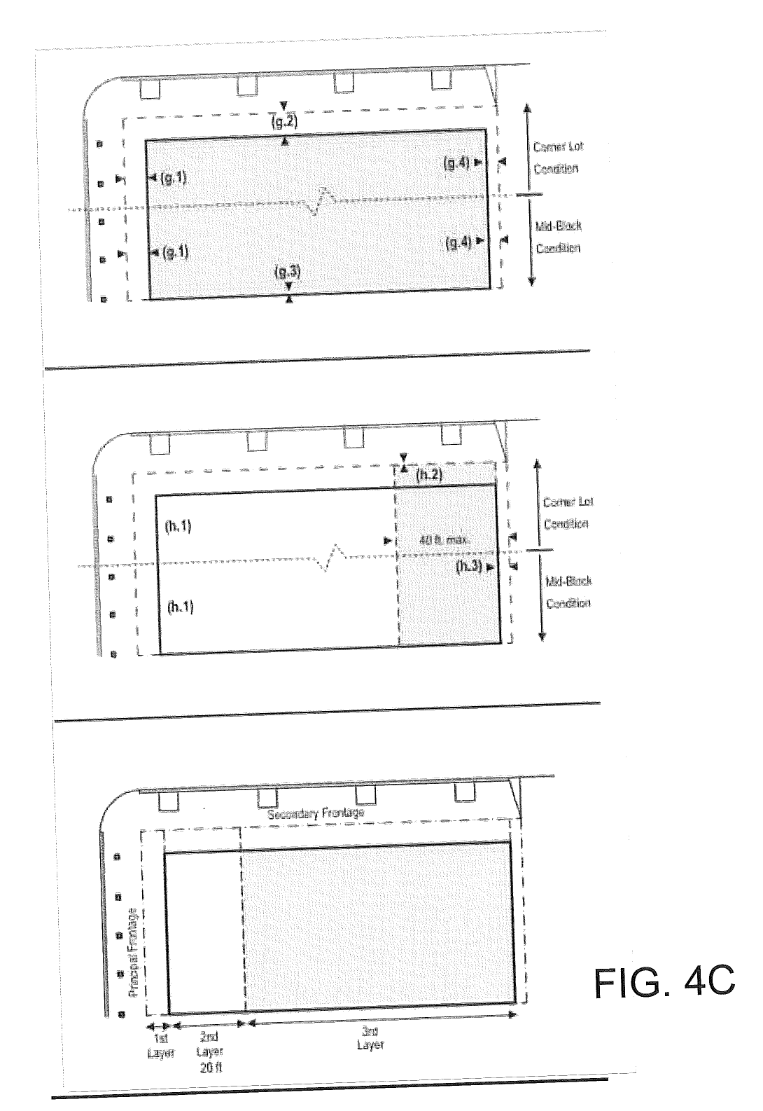

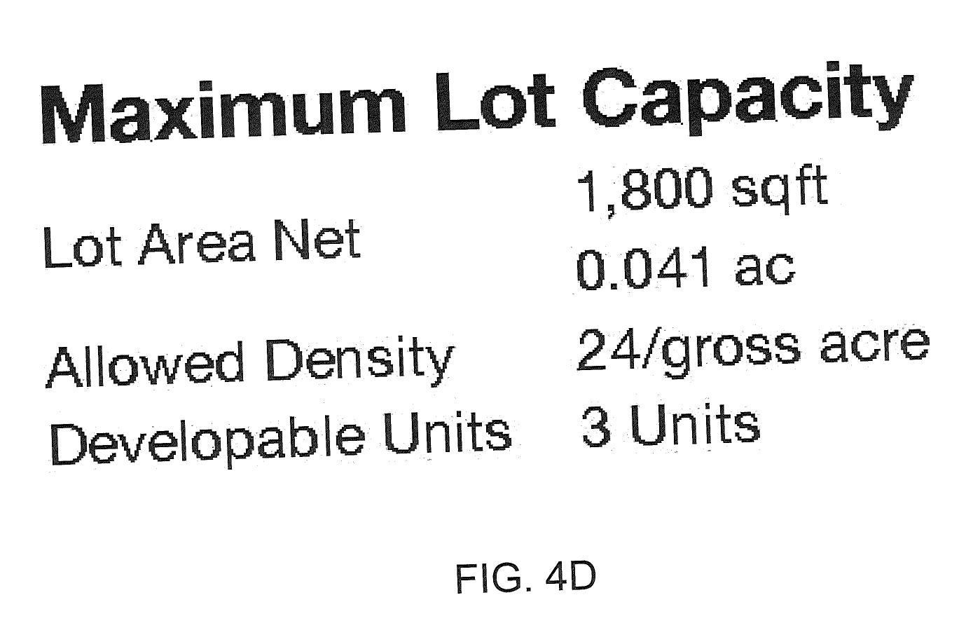

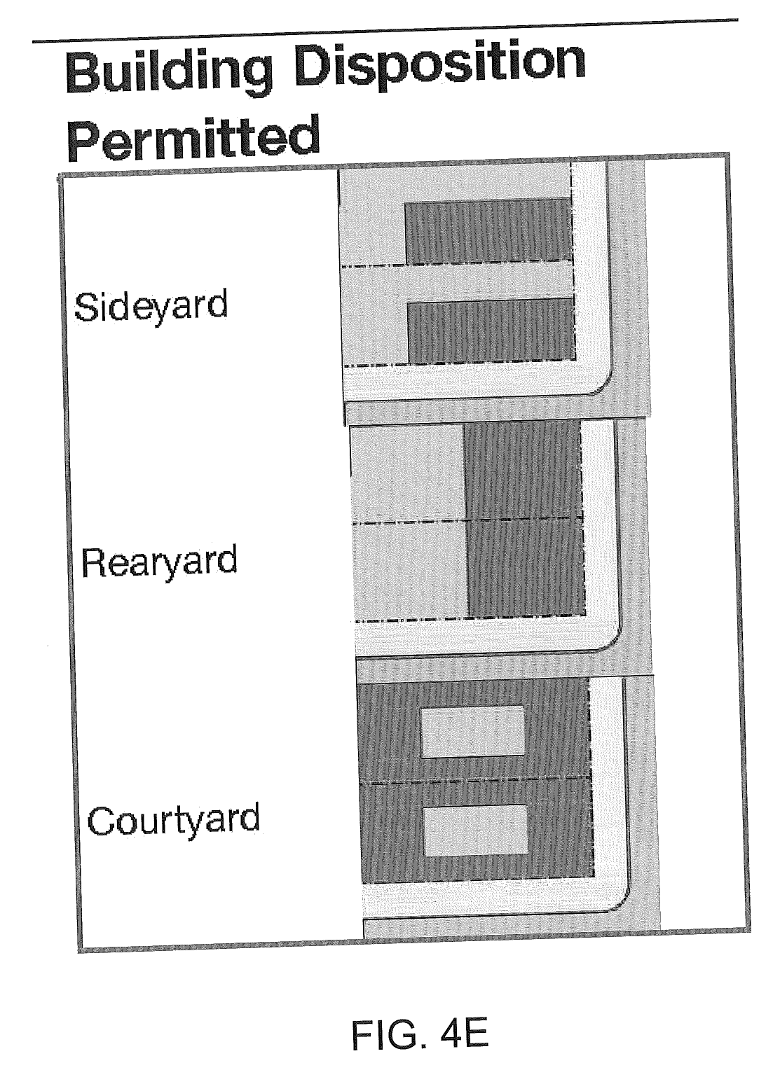

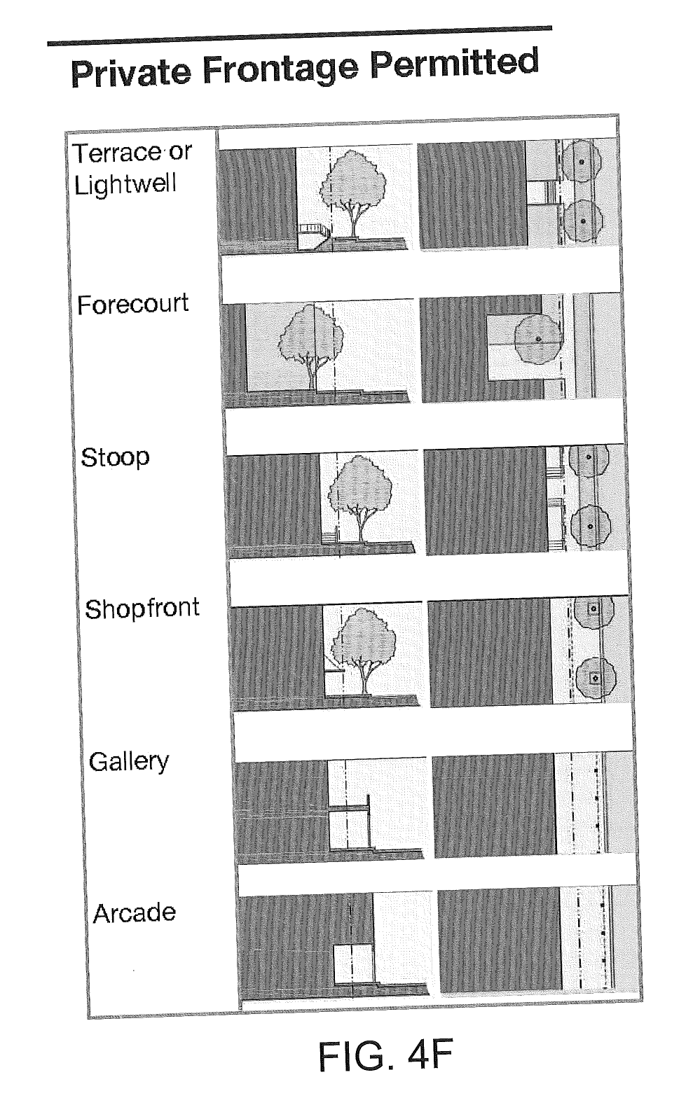

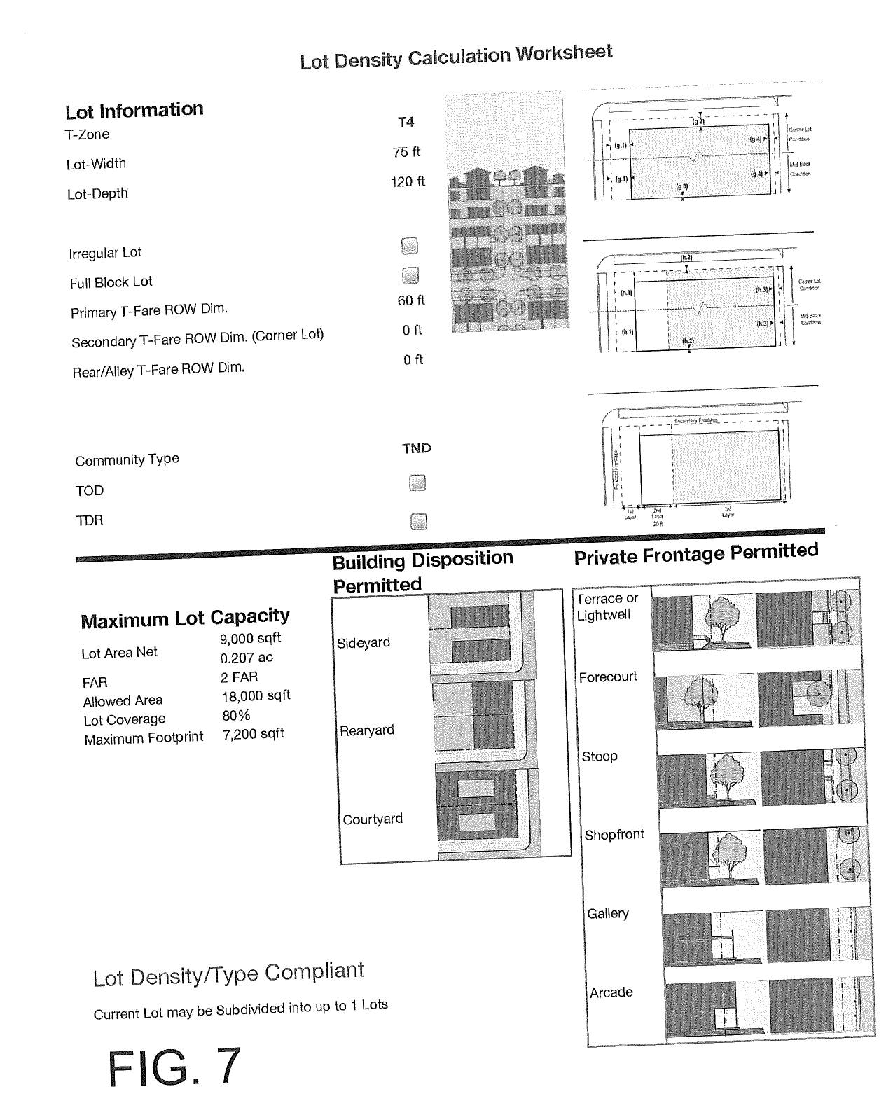

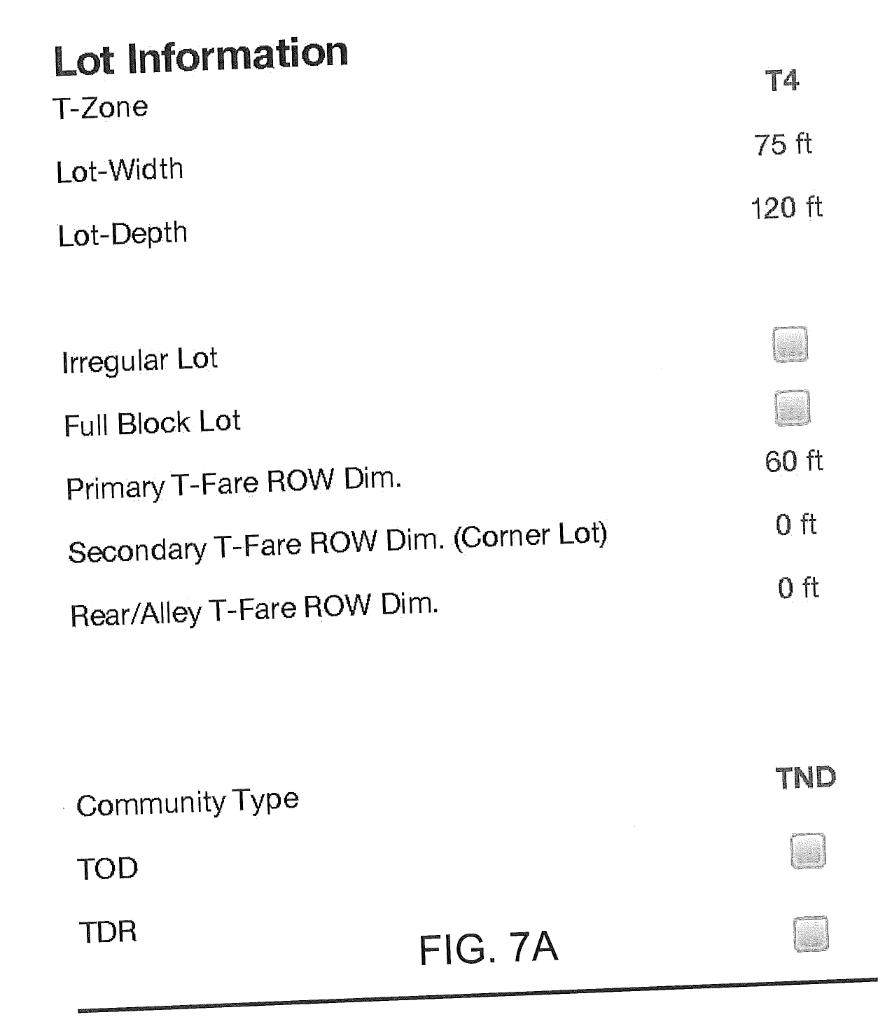

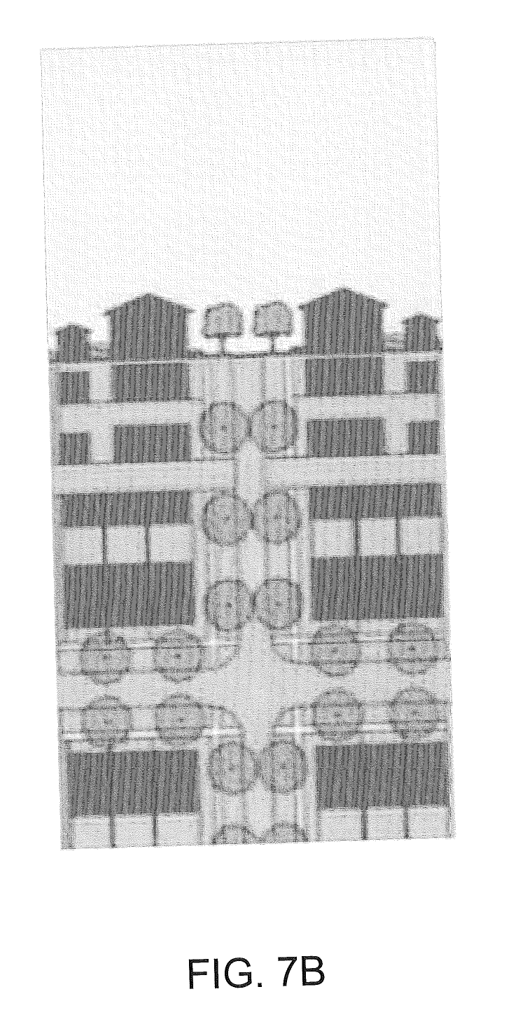

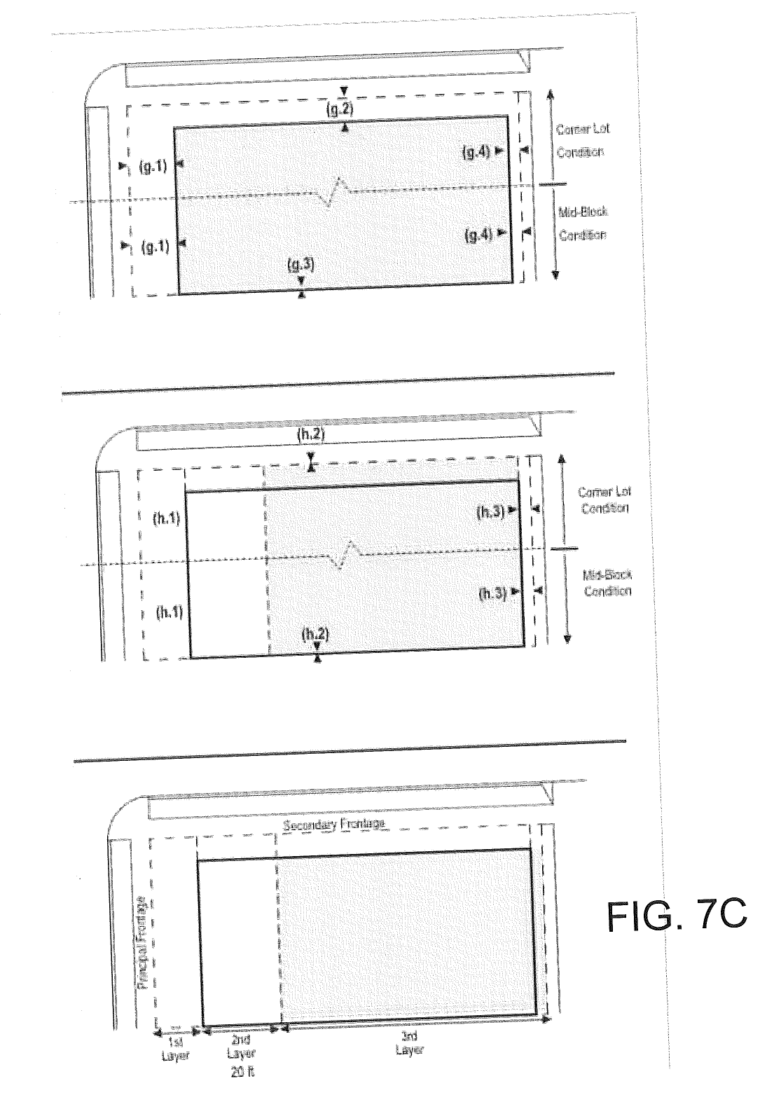

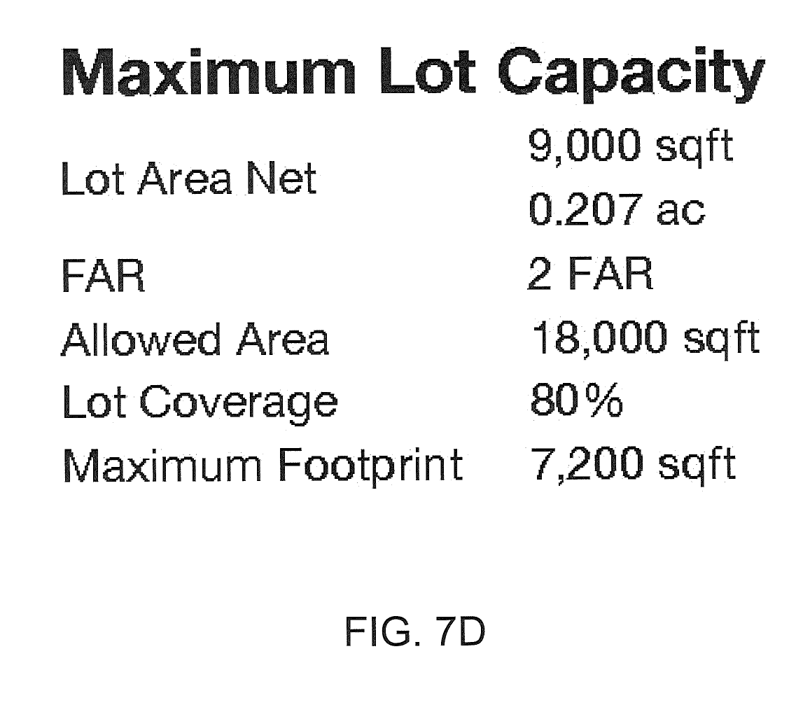

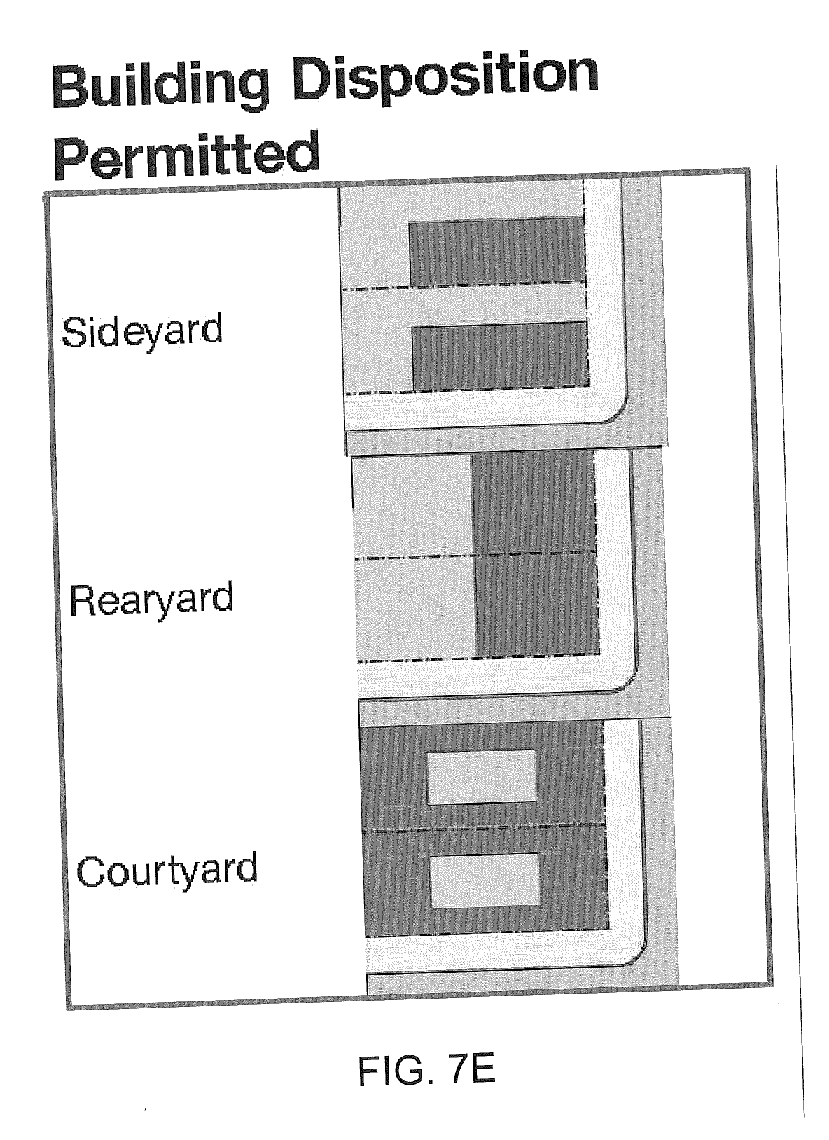

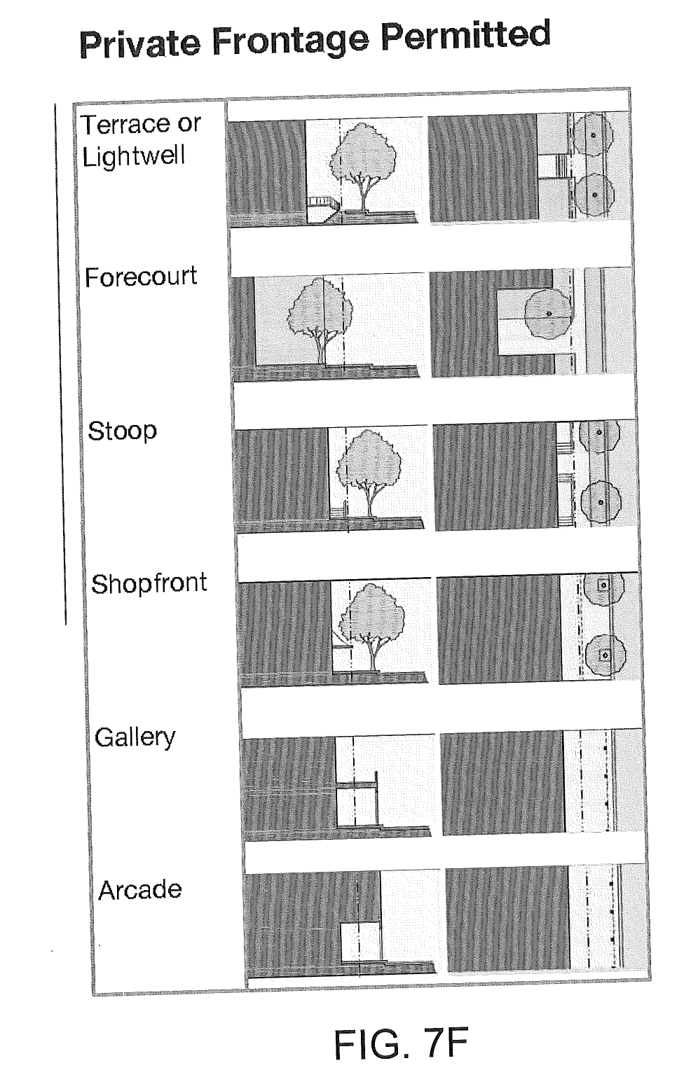

FIGS. 4-9 show interfaces that would be seen by a user, such as a developer or an employee of a developer. In FIGS. 4-6, the form-based code is density based and in FIGS. 7-9, the form-based code is floor area ratio (“FAR”) based. In this example, once a user inputs lot information in an initial interface, they can then “test” the project. Such testing will allow users to further develop their projects in subsequent interfaces.

Each of these examples shows Section of a Lot Density Calculation Worksheet. Each example may include a Lot Information Section, Givens Section, or a general Input Area, where a user can input values. These types of input areas may include T-zone type, lot-width, lot-depth, dimensions for primary T-far right of ways, rear or alley T-Fare right-of-ways, Setback Values for Principal and Secondary Buildings (e.g. an outbuilding). One of these sections may also include selection boxes or other yes/no indicators, which allow a user to indicate whether the lot is a full block lot and/or an irregular lot. A Community Type Section may also be provided, which includes selection boxes, which allow a user to indicate whether the community type is a Transit-Oriented Development (“TOD”) or Transfer of Development Rights (“TDR”) Purchased type. Worksheet sections may further include schematic representations of lot density and/or lot conditions. The latter, for example, can include corner lot conditions, mid-block conditions, and/or proposed frontages. Maximum Lot Capacity Sections can also be configured to show calculated, predetermined, or determined values for lot area, allowed density, and the number of Developable Units. Finally, a Results Section may indicate Lot Calibration Results, summarizing the density allowed and type of unit (e.g. developmental or density), a Suggested Building Layout, and a General Indicator, which states whether or not the Lot Density/Type is compliant.

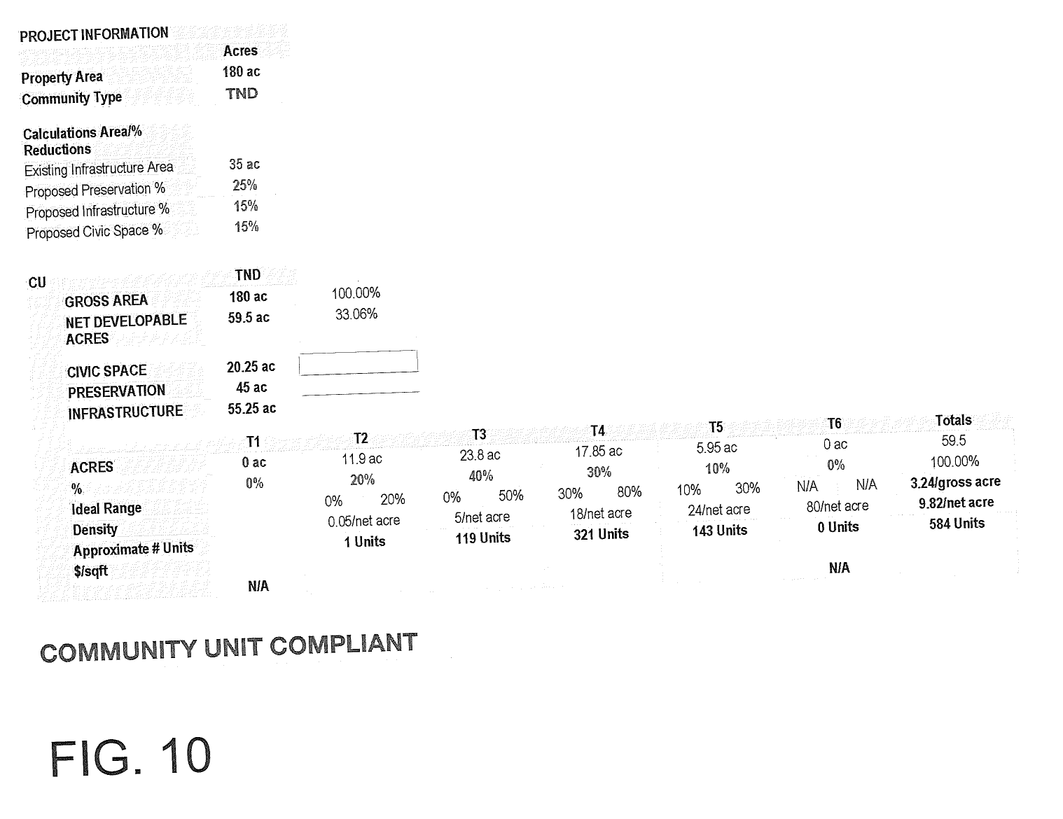

FIG. 10 shows a community development interface. In this interface, a user, such as a community developer, would use the system to analyze certain property yield. The yield could include parameters in terms of units, densities, and open space, among other parameters. In the example shown in FIG. 10, an input area may be provided such that a user may enter Property Area and/or Community Types. Calculation Area/%Reductions Section may be also included based upon the Existing Infrastructure Area and/or percentages of Proposed Preservation, Proposed Infrastructure, and Proposed Civic Space. A separate Indicator may also be used to signal whether or not a Community Unit is compliant. FIG. 10, for example, shows the term “Community Unit Compliant” because the determined values indicate compliance.

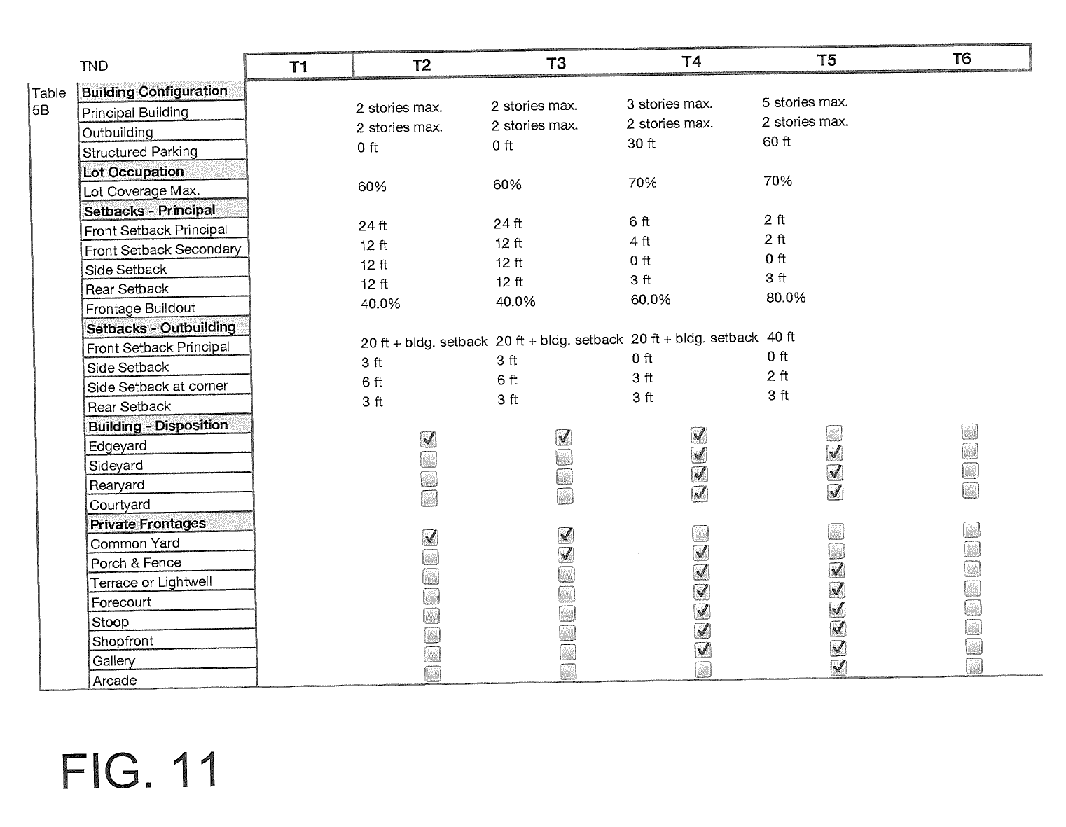

FIGS. 11-14 show various types of calibration tables. These tables can be customized based on the specific requirements, laws, etc. of a municipality. Moreover, these tables may be configured to represent databases from which the calculations used in the system are derived. Each of these tables may include data entered into the table relating to Building Configurations, Lot Occupation/Coverage, Setback Configurations, Building Dispositions, Private Frontages, Newly Platted Lots, Infill, Densities, Transferable Building Functions, Transit Overlays, and Civic Zones.

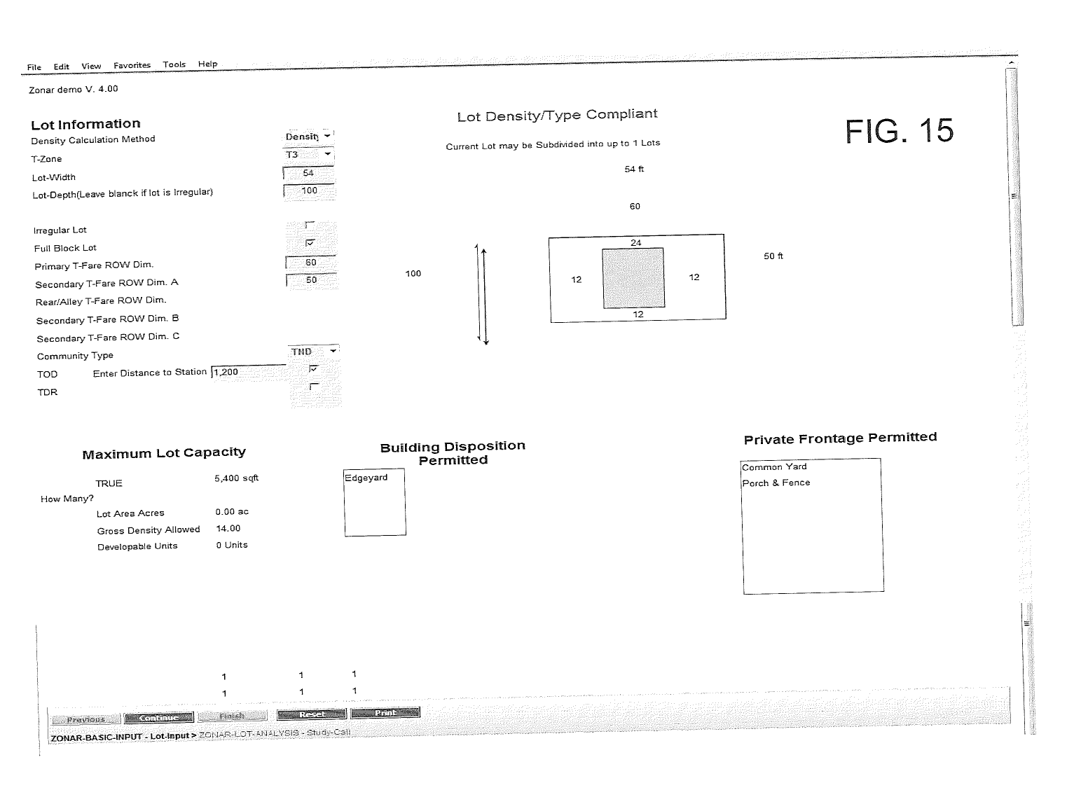

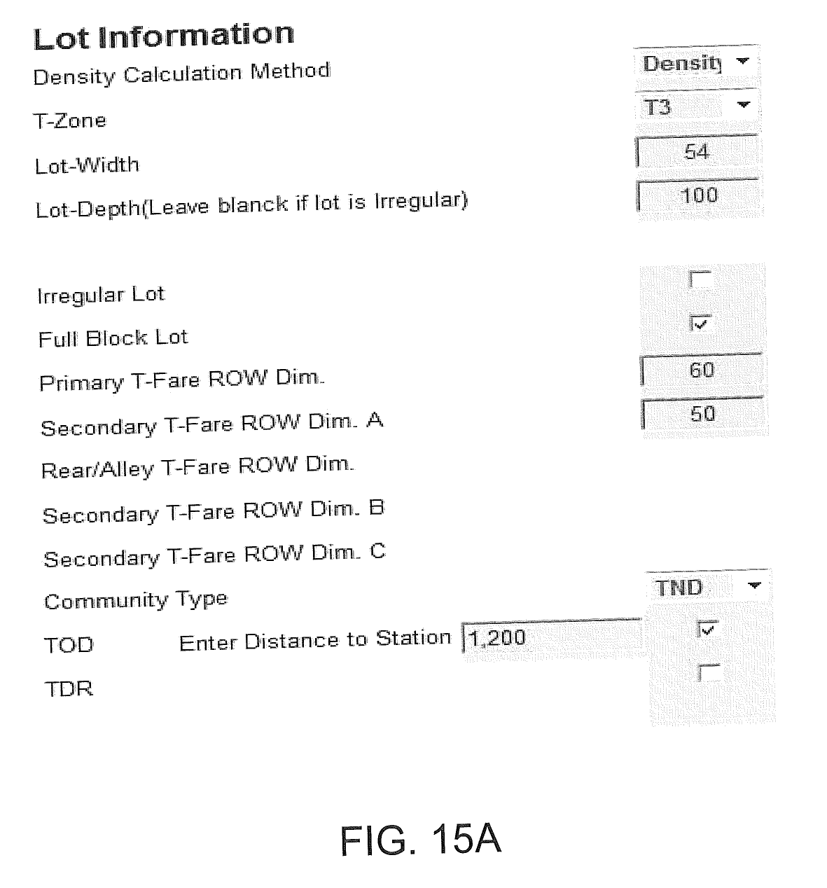

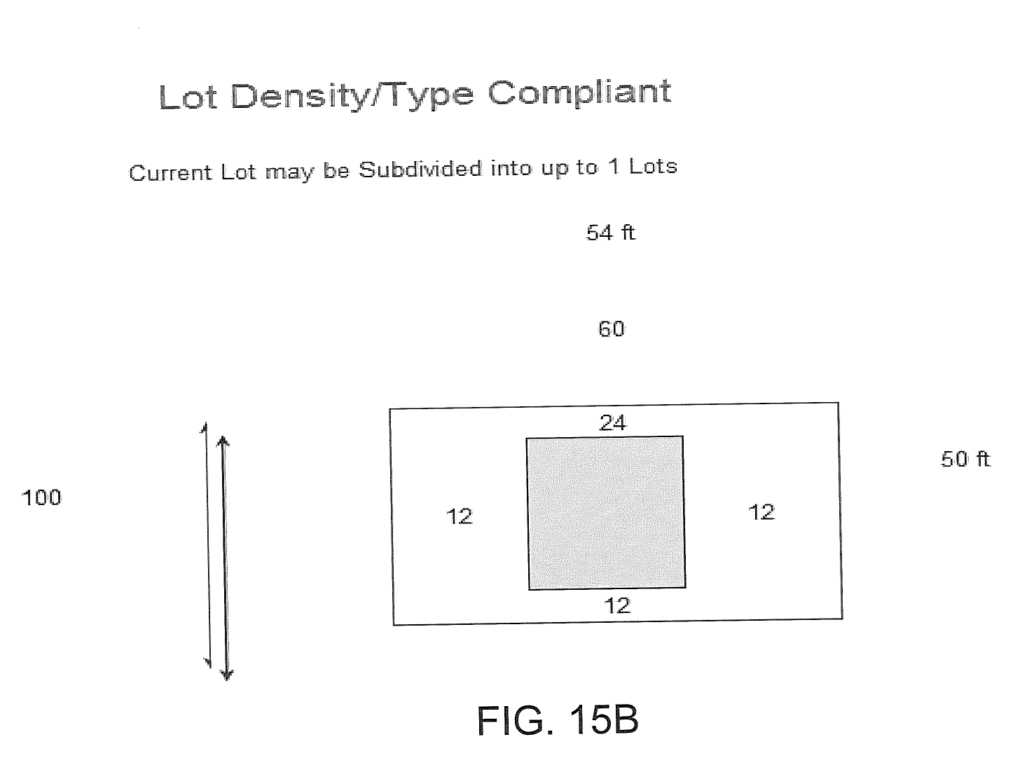

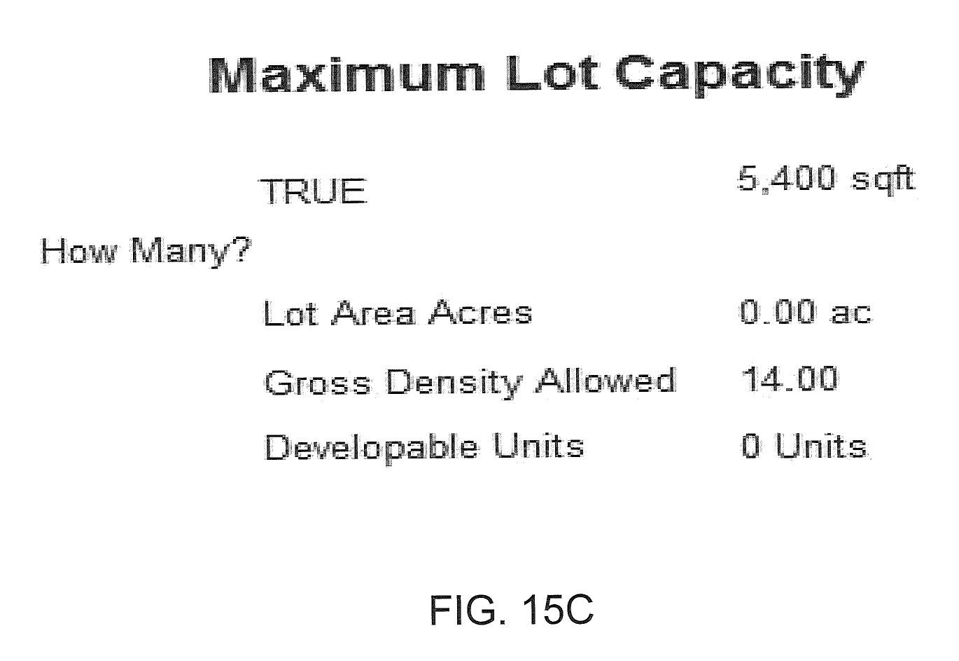

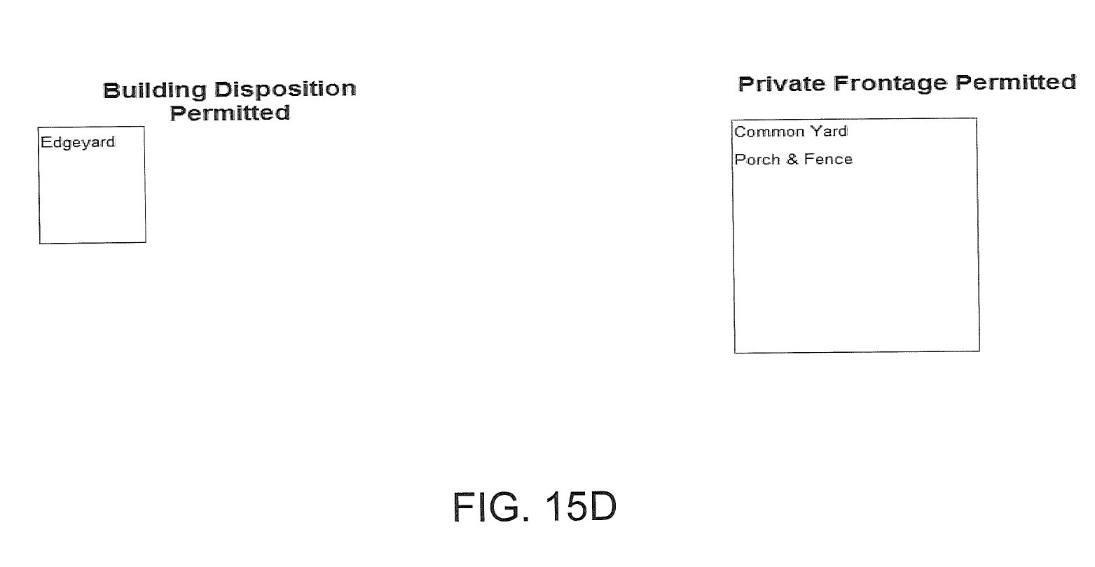

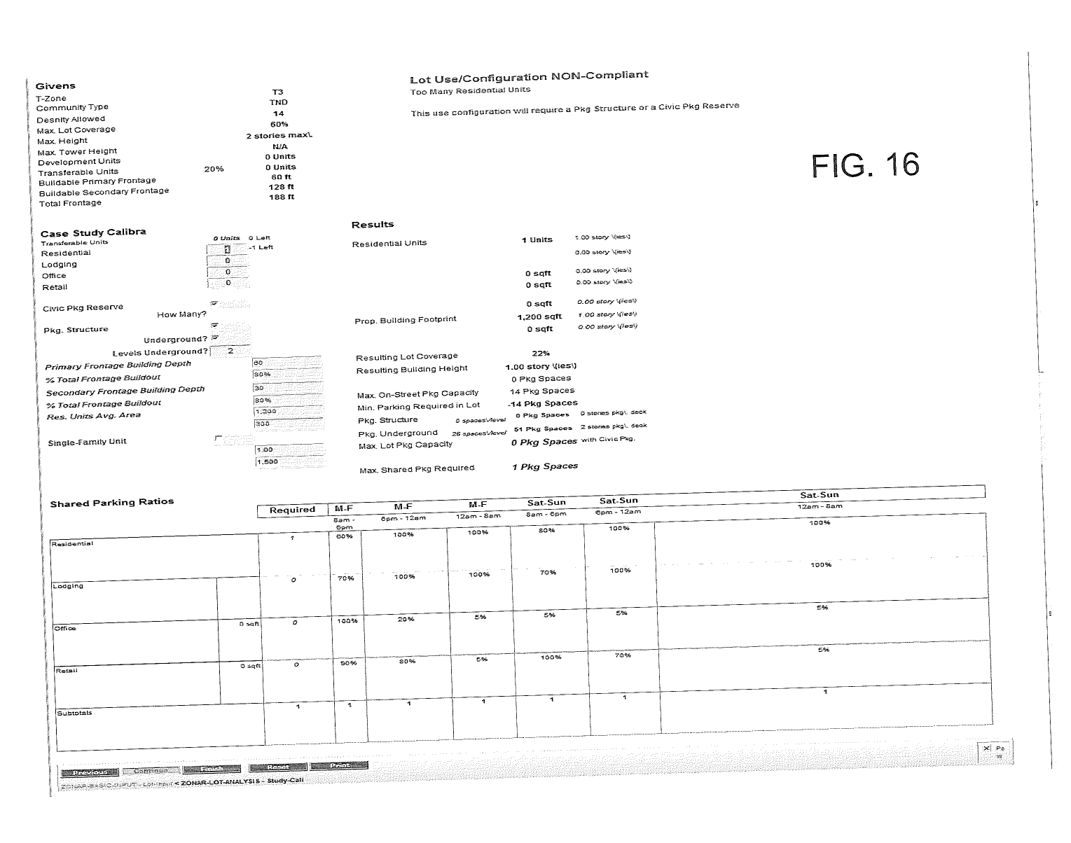

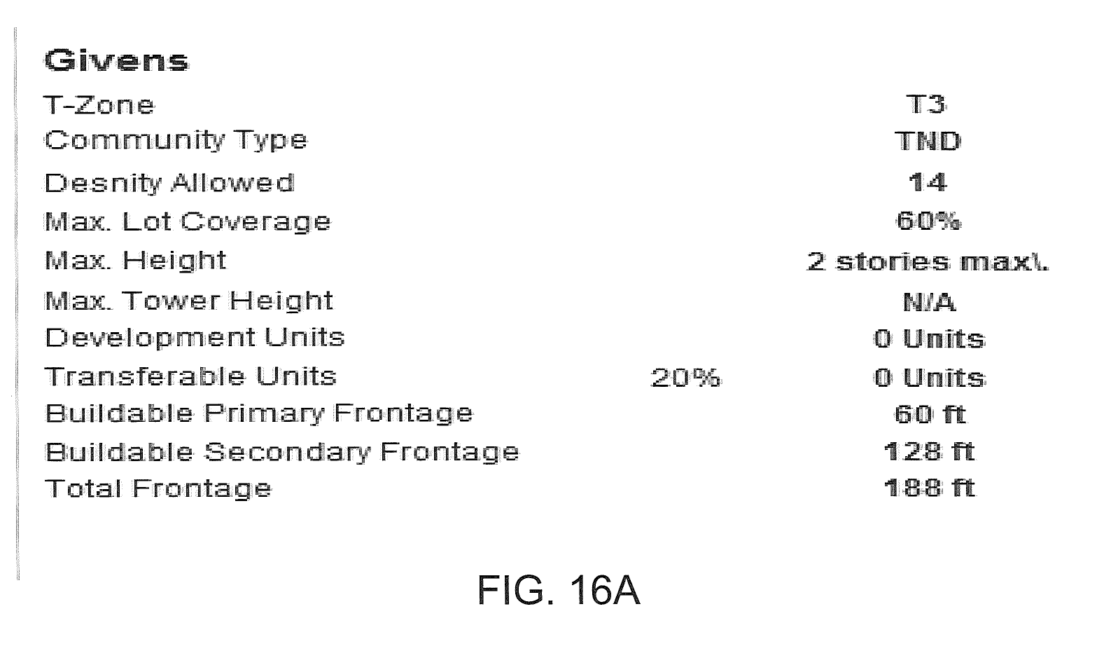

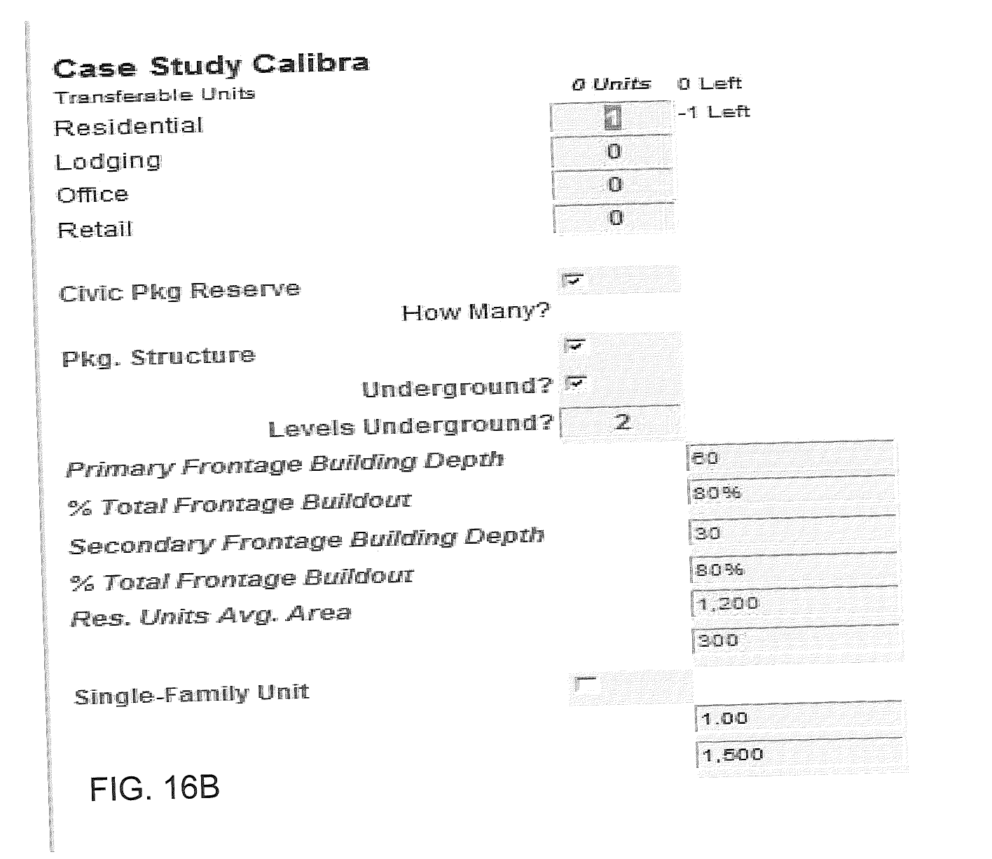

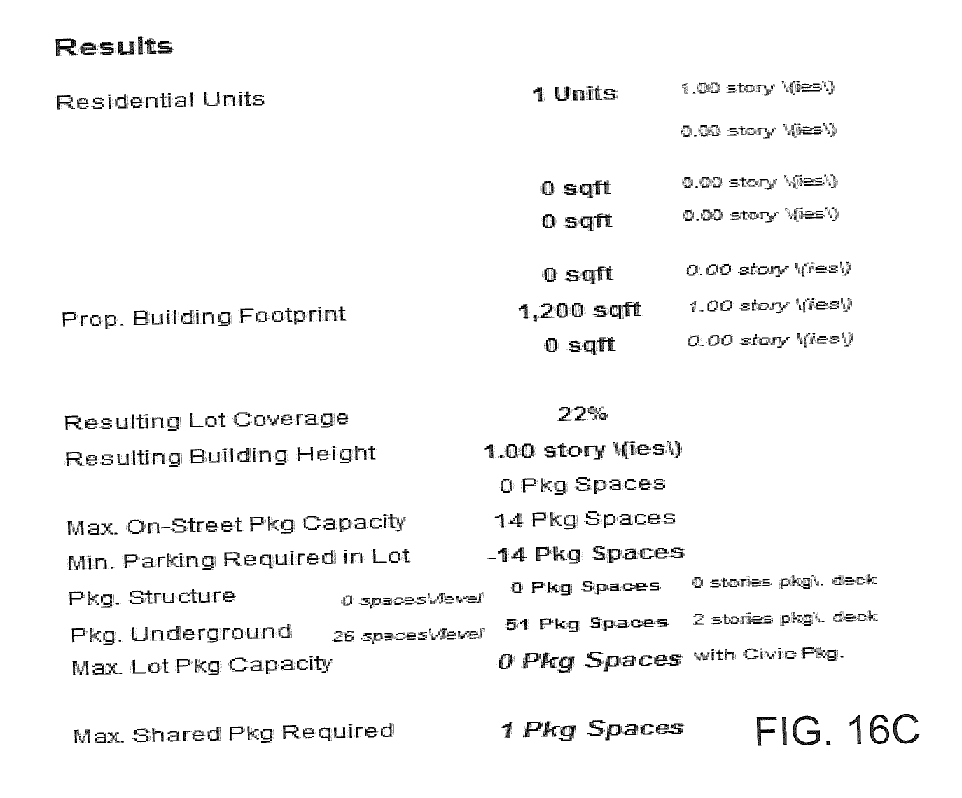

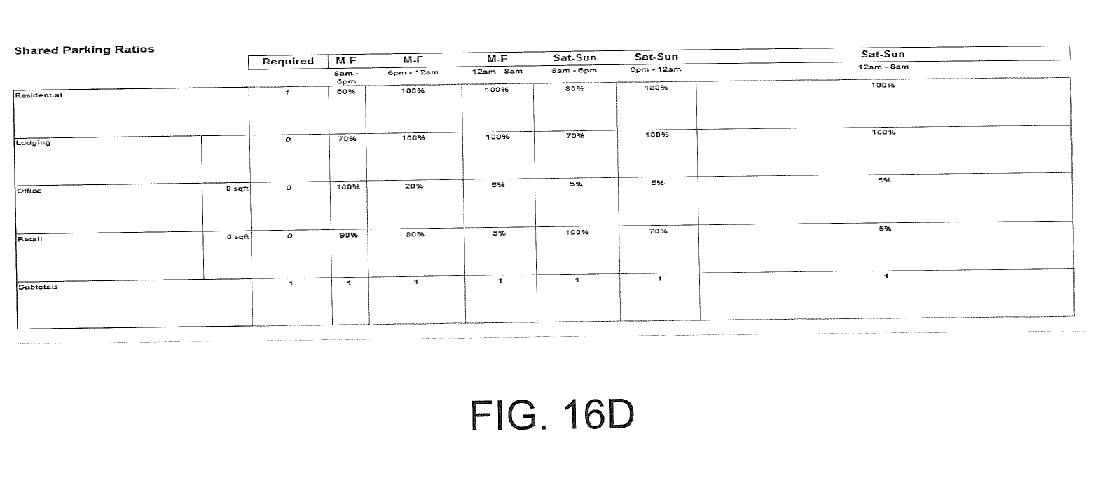

FIGS. 15 and 16 show alternative views of Zoning Compliance software interfaces. FIG. 15 shows interface examples that could be used by a municipality. The left side of FIG. 15 provides input interfaces for property information such as T-zone type, lot-width, lotdepth, dimensions for primary and secondary T-far right of ways, and primary and secondary rear or alley T-Fare right-of-ways. This section also includes selection boxes, which allow a user to indicate whether the lot is a full block lot and/or an irregular lot. The Community Type Section includes selection boxes, which allow a user to indicate whether the community type is a Transit-Oriented Development (TOD) or Transfer of Development Rights (“TDR”) Purchased type. If a TOD type is selected an option is included to enter a pre-specified distance to a transit station, for example. The Interfaces shown in FIG. 15 also includes sections for Maximum Lot Capacity, Building Disposition, and Private Frontage, where the latter two sections indicate the type of permitted building disposition and/or private frontage. These interfaces further include indicators, which allow a user to assess whether or not the Lot Density/Type is compliant and how many subdivisions are allowed. A schematic representation of the lot may also be included showing perimeter values, for example.

FIG. 16 shows interface examples to determine whether or not a Lot Use or Configuration is Compliant. This example includes a Givens Section, a Case Study Calibration Section, a Results Section, and a Shared Parking Ratios Section. These interfaces further include indicators, which allow a user to assess whether too many residential units where specified and/or whether the configuration will require one or more parking structures or a reserve for civic uses

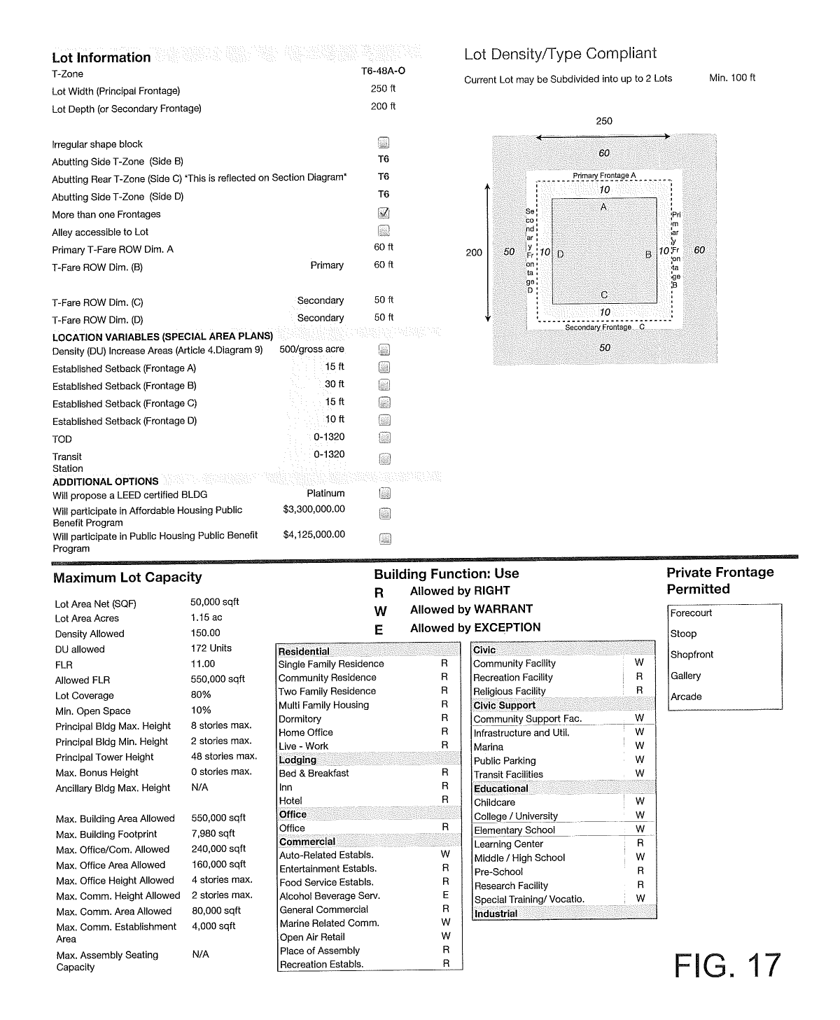

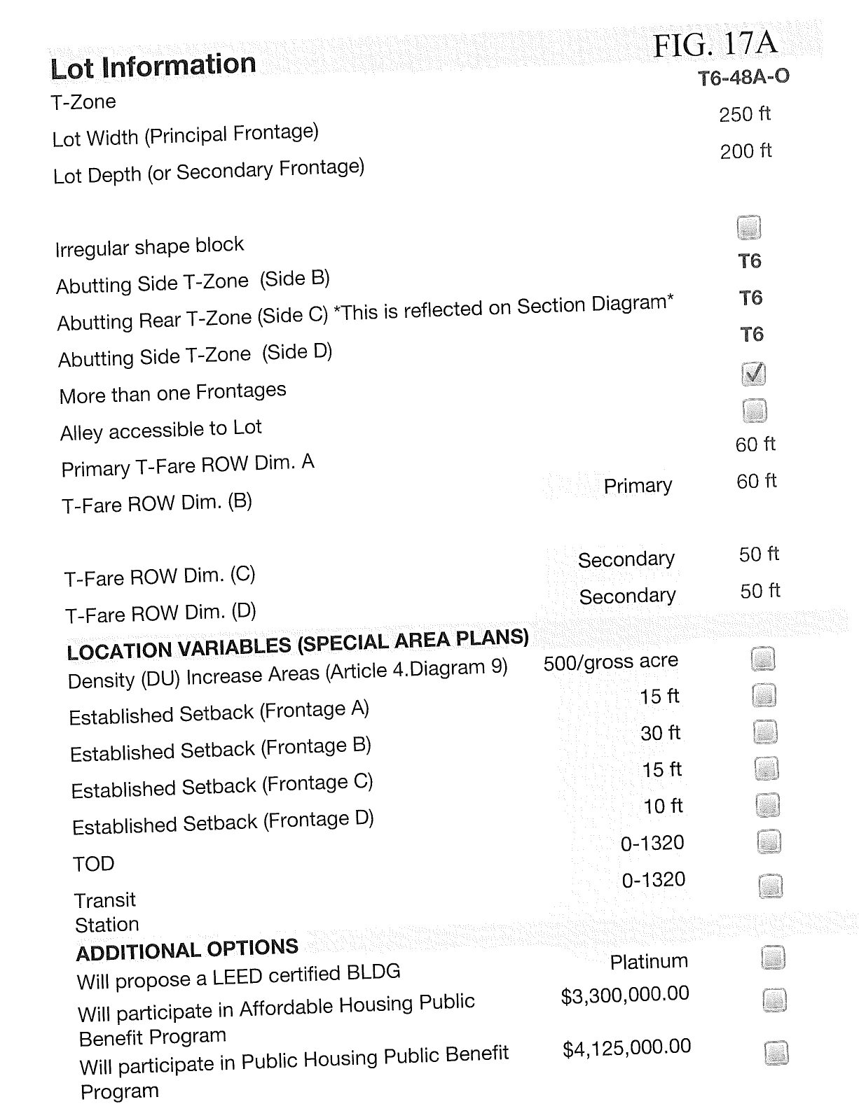

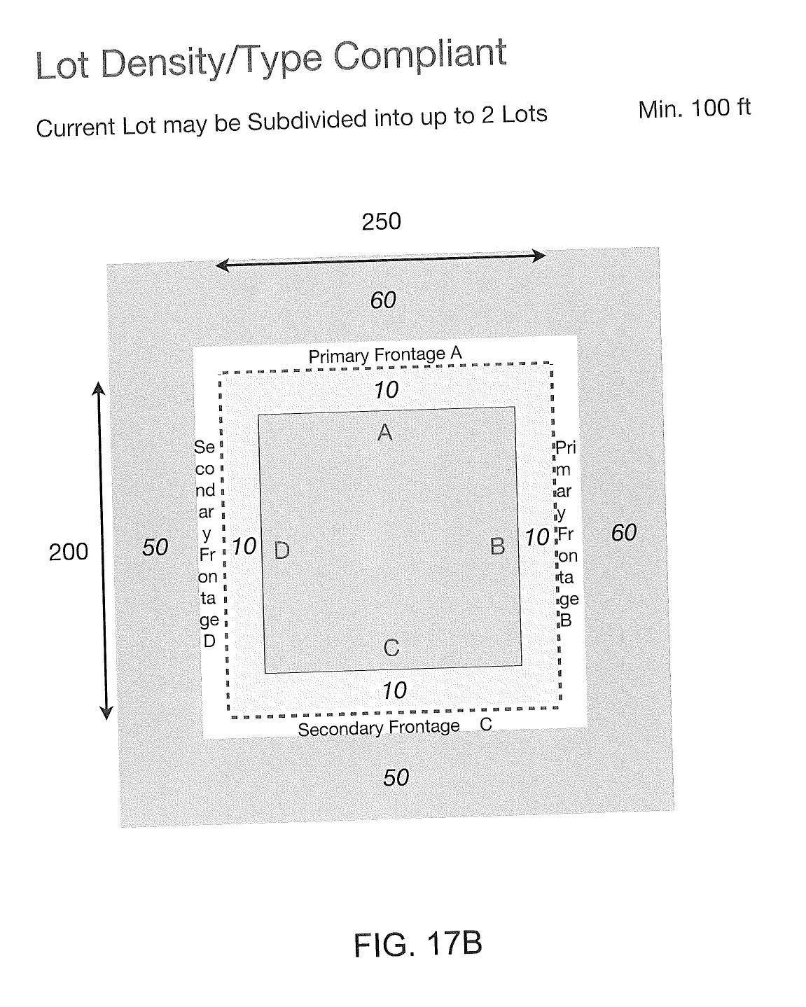

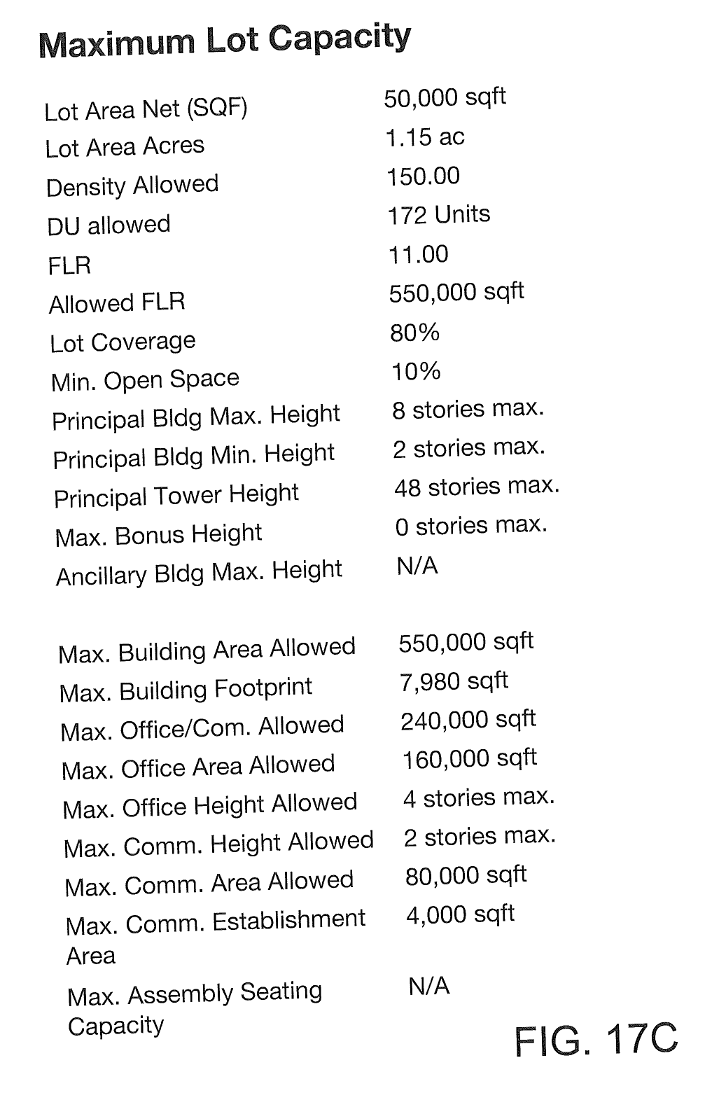

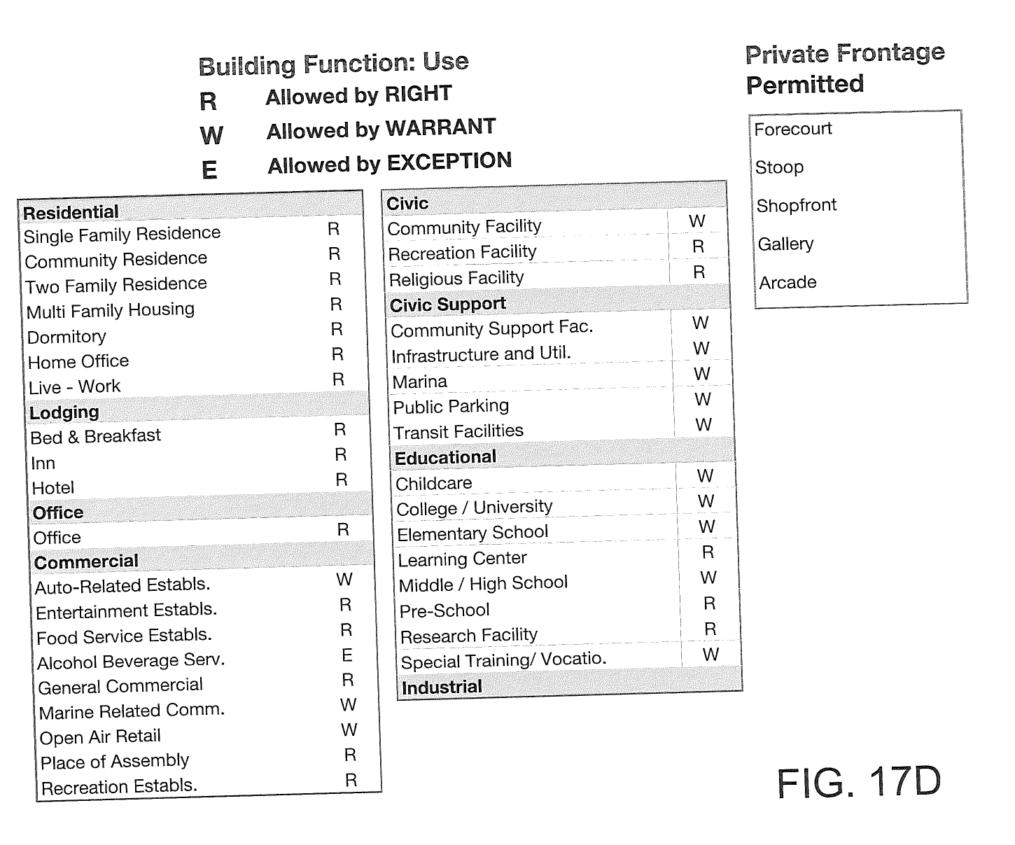

FIGS. 17-21 show interfaces from an implemented system for determining zoning code compliance. The system implements a code, which sets forth municipally sanctioned standards for specified zones and refers to the municipality's zoning map. The map illustrates designated zones for each property type, which is regulated by the code. In use, the system includes two primary steps for those interested in assessing zoning code compliance. The first step including finding a property to be assessed on the municipality's zoning map. After finding the property on the map, a user would determine the type of zoning that applies to the property. The type of zoning will reflect the zoning regulations that are currently in force in the municipality, including general regulations for each municipal zone, architectural standards, and building placement standards.

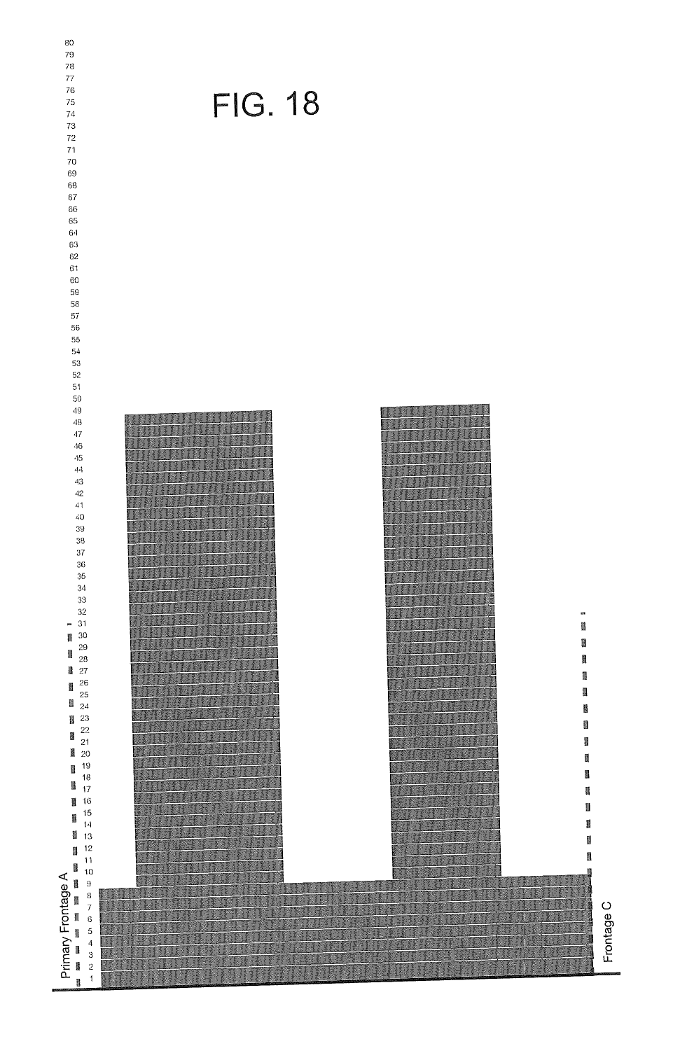

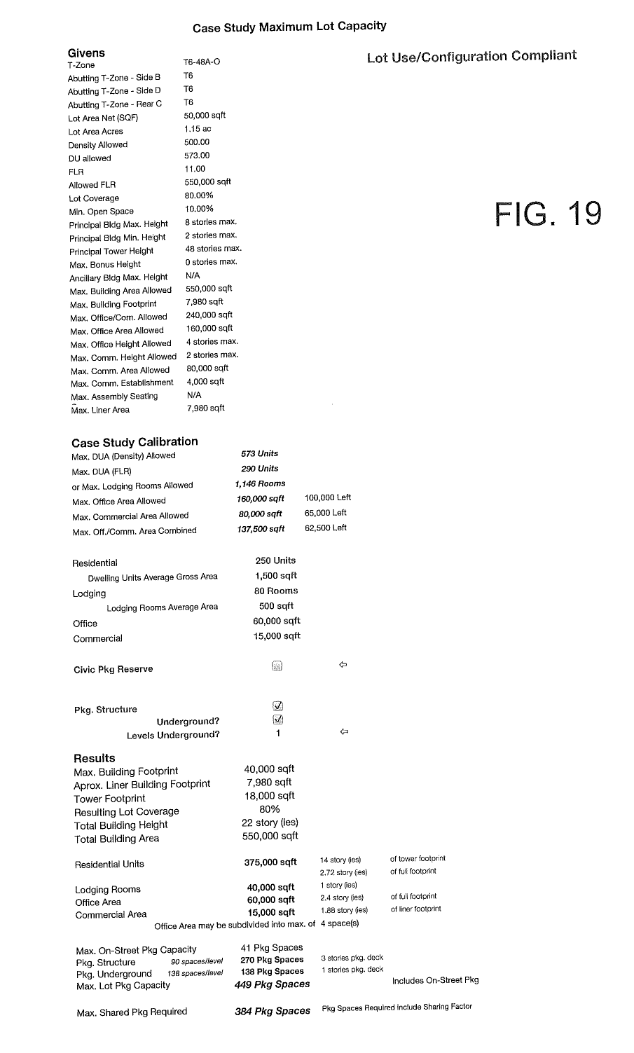

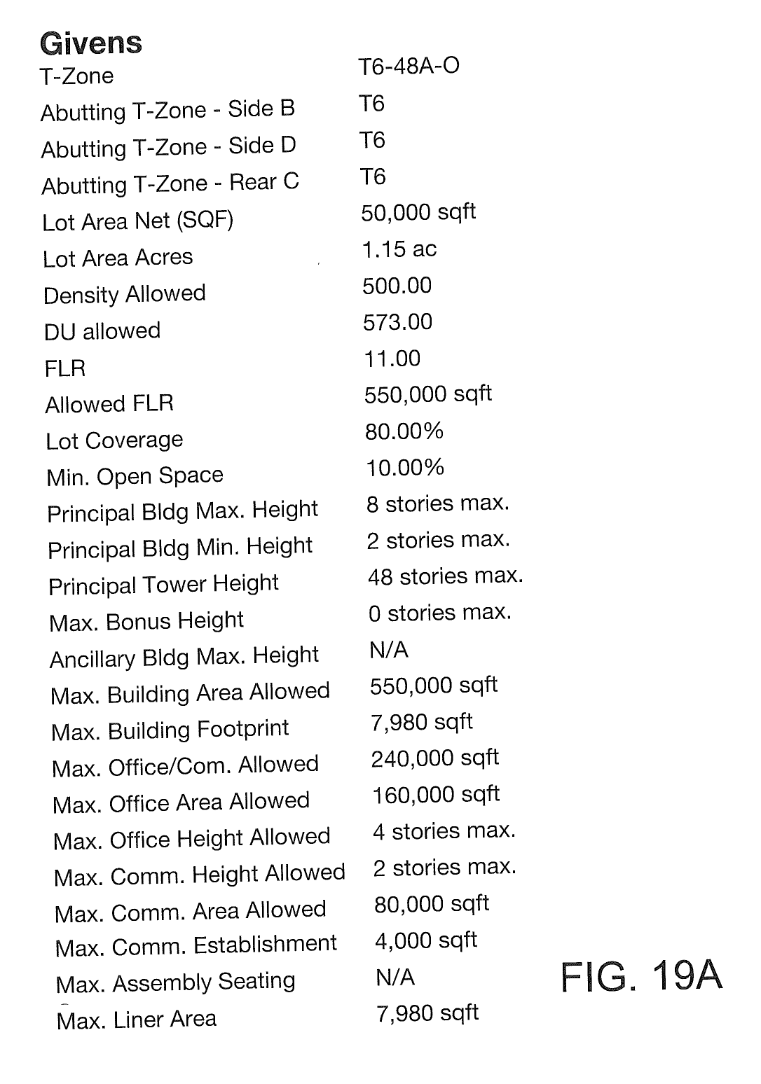

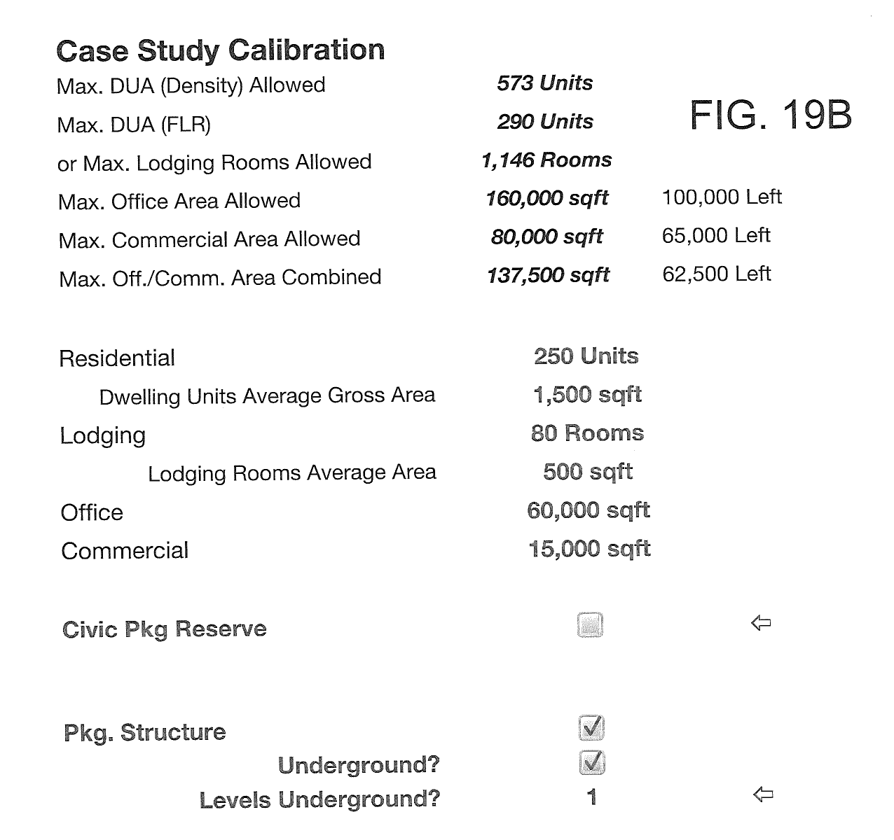

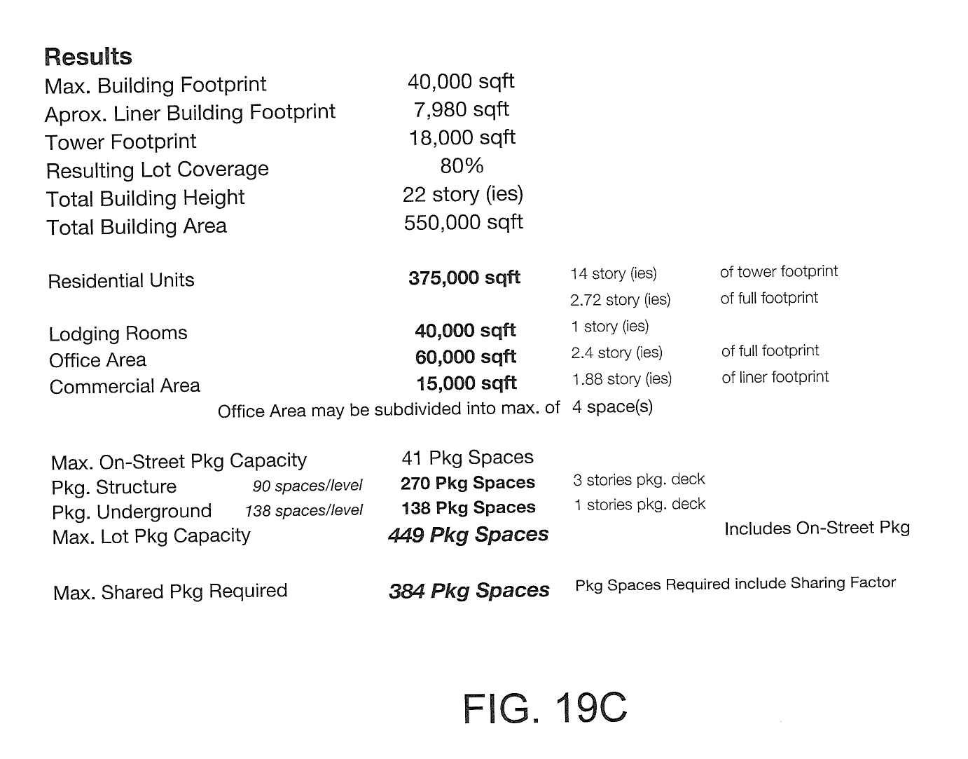

In using this system, various property parameters are entered by a user. Afterwards, results will indicate whether lot density/type is compliant, as well as indicate possible subdivisions. Lot information is initially input into the system. Such information includes T-Zone type, lot-width, lot-depth, types of abutting side and rear T-Zones, and right of way dimensions. Selection boxes are also included for a user to indicate whether there is more than one frontage, whether an alley is accessible to the lot. Additional location variables may also be input into the system and include an indication of density increase areas, established setbacks, and distances to TOD's and transit stations. Additional customized options may also be included, depending on the municipality's specifications and include, but are not limited to indications of building certifications and participation in affordable public housing programs. Schematic representations may be included, as shown in FIG. 17B, as well as Compliance Indicators. Implemented systems can also include more detailed interfaces having Maximum Lot Capacity, Building Function: Use, and Private Frontage Permitted Sections, as shown in FIG. 17C-17D. FIG. 18 is a graphical representation of a possible building section based on code determined setbacks, lot coverage, maximum heights, and maximum number of high-rise towers allowed . FIG. 19 shows interfaces for determining whether Lot Use/Configuration is compliance. Here, a Givens Section is shown including parameters relating to T-Zone types, new lot area, lot area acreage, allowed density, Dwelling Units (“DU”) density, Floor Lot Ratio (“FLR”), Building heights, footprint, allowed areas, maximum community heights, maximum office heights, maximum assembly eating, and maximum liner building areas.

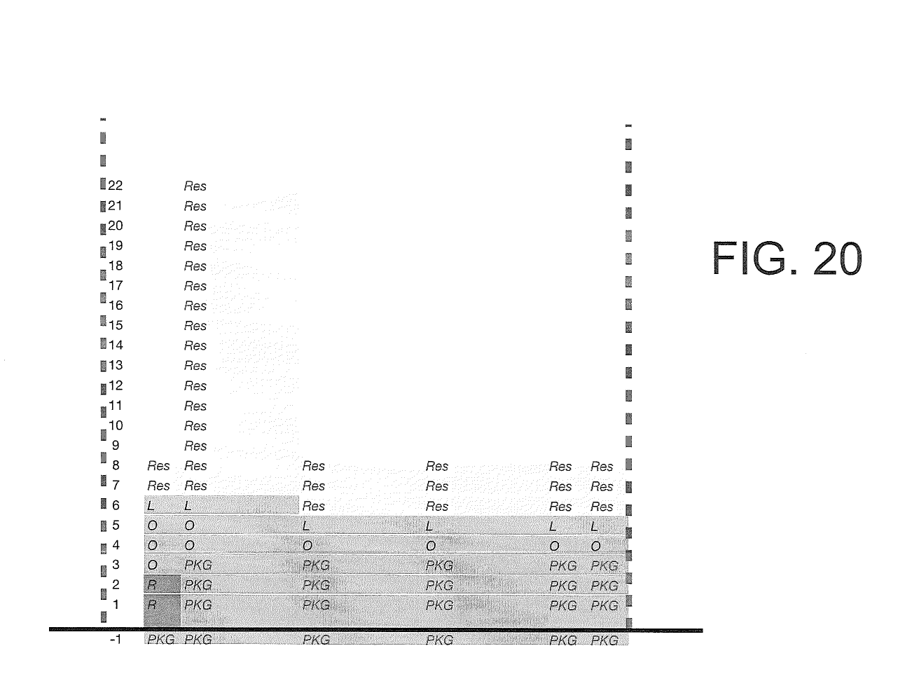

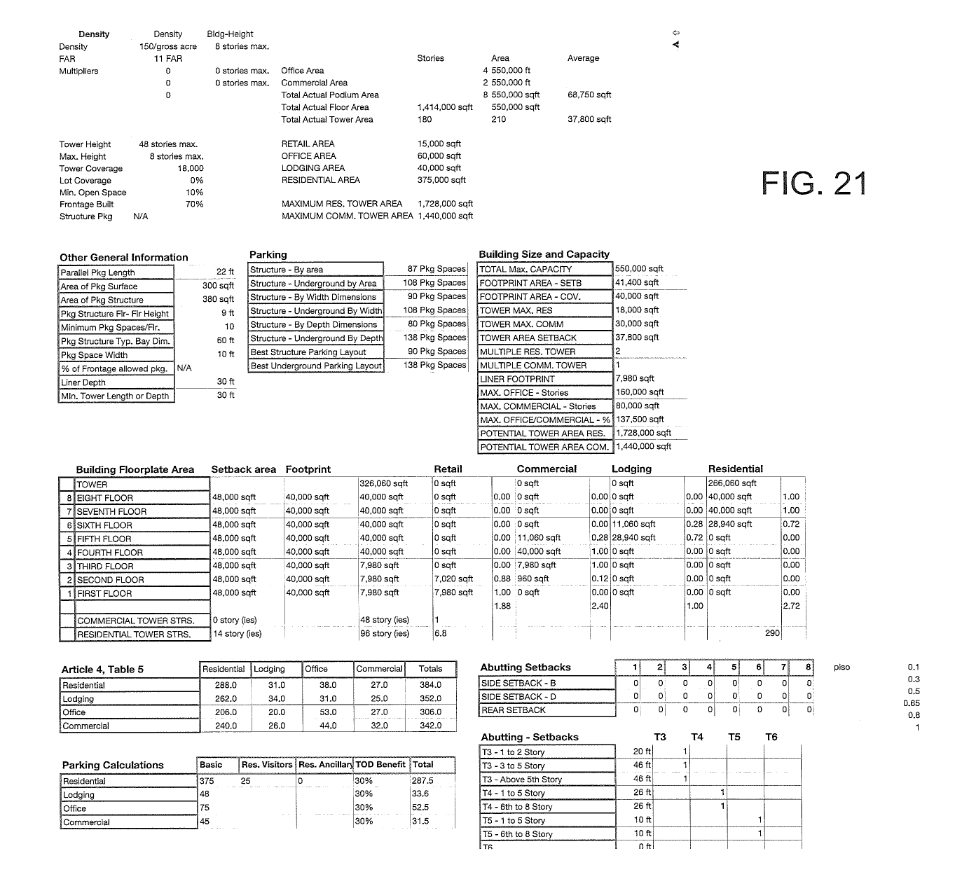

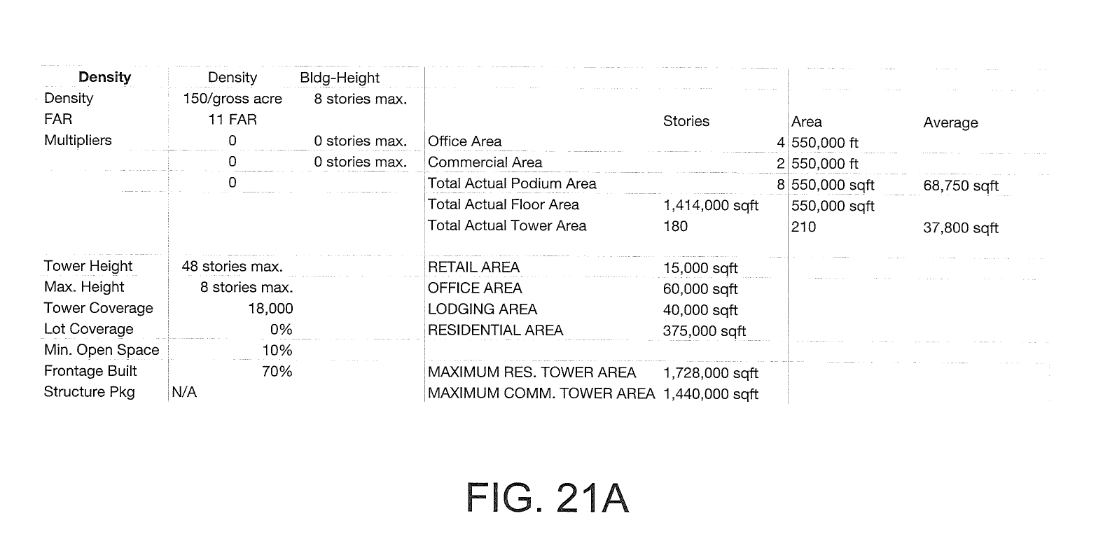

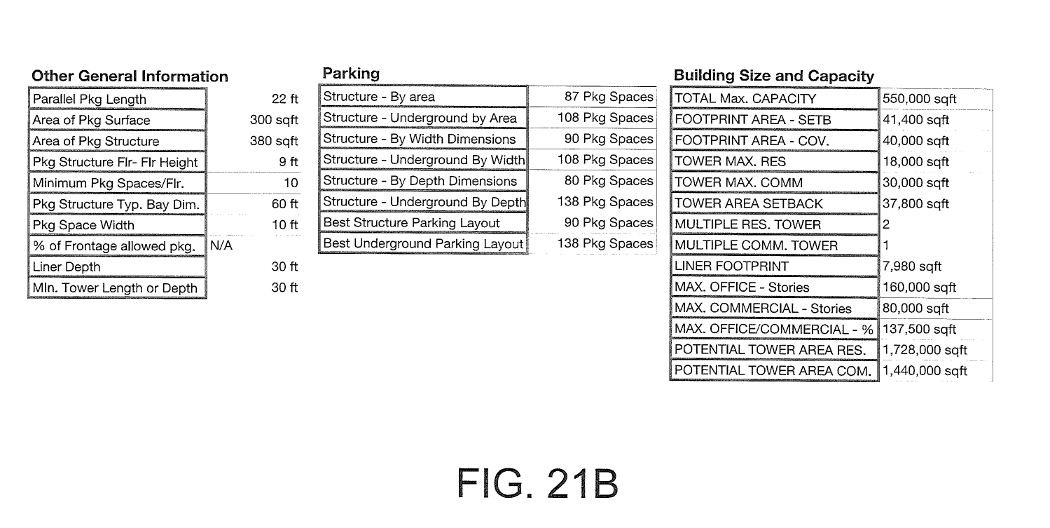

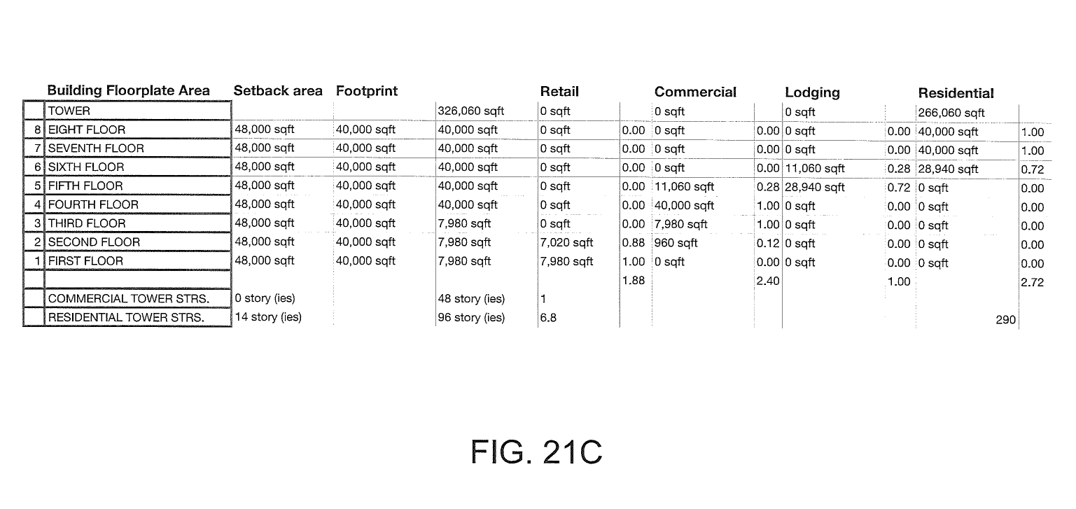

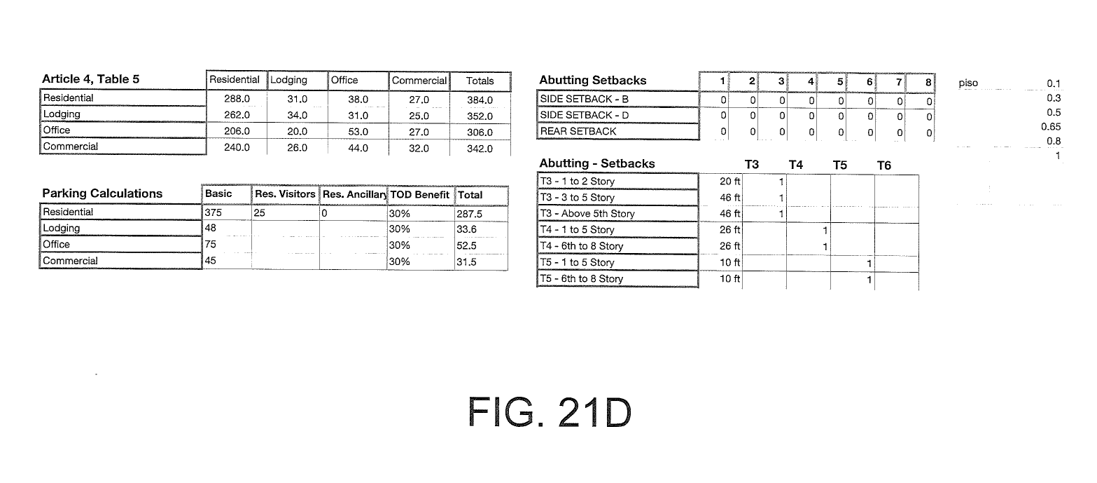

Furthermore, the user could test different mixes of uses, such as number of DU, average area of each DU, amount of lodging units, average area of lodging units, commercial area, office area, and parking structure alternatives. FIG. 20 is a graphical representation of the resulting possible building section based on all the given parameters, and on the input parameters selected by the user. This diagram depicts typical location of uses according to best practices standards (Commercial goes on ground level, Office goes above Commercial, Lodging goes below private residences, and Private Residences goes above all other uses.), also the parking structure required to meet the needs of the selected uses, and the repercussion it will have on the building use distribution. FIG. 21 depicts some of the calibration tables of standard and modifiable parameters, information which affect most of the calculations. Some of these parameters are, typical parking spot dimensions, minimum and maximum liner building dimensions, and maximum and minimum high-rise tower footprints.

The examples and implementations shown herein are in no way to be construed as limiting the inventive concepts included herein.

Thus, computer-implemented methods and systems for determining zoning code compliance are disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A computer-implemented system for determining zoning code compliance, comprising:
at least one input interface for receiving property information;
at least one computer-readable program code, executed on a computer, that calculates zoning code criteria and assessing zoning code compliance, using the property information; and
at least one output interface for displaying assessment of zoning code compliance.

2. The computer-implemented system of claim 1, wherein the at least one computer-readable program code program is stored in computer-readable storage media.

3. The computer-implemented system of claim 1, further comprising an input interface for receiving real-time zoning code parameters.

4. A computer-implemented method of determining zoning code compliance, comprising:
inputting property information into a computer-implemented software interface;
calculating zoning code parameters based upon the inputted property information;
assessing zoning code compliance based upon the calculated zoning code parameters; and
outputting results of zoning code compliance in an output interface.

5. The computer-implemented method of claim 4, wherein the computer-implemented software interface is coupled to computer-readable storage media.

6. Computer-implemented program code for determining zoning code compliance, comprising:
a computer-readable storage medium comprising the computer readable program code configured for execution on a computer for:
(A) entering, by way of human intervention, lot information for a property;
(B) calculating parameters specified by the zoning code based upon entered lot information;
(C) determining whether calculated parameters are in compliance with zoning code parameters; and
(D) outputting whether the calculated parameters are in compliance with the zoning code parameters.
